(19) United States
(12) Patent Application Publication
(10) Pub. No.: US 2012/0146831 A1
(43) Pub. Date: Jun. 14, 2012

(54) Multi-Rate Algebraic Vector Quantization with Supplemental Coding of Missing Spectrum Sub-Bands

(76) Inventor: Vaclav EKSLER, Sherbrooke (CA)

(21) Appl. No.: 13/162,183

(22) Filed: Jun. 16, 2011

Related U.S. Application Data
(60) Provisional application No. 61/355,903, filed on Jun. 17, 2010.

(51) Int. Cl. H04N 7/26

(52) U.S. Cl. 341/200

(57) ABSTRACT

In a multi-rate algebraic vector quantizer and quantizing method for coding spectral coefficients of a plurality of frequency sub-bands, a quantizer portion is supplied with the spectral coefficients of the sub-bands. The quantizer portion has a plurality of codebooks each including a plurality of vectors, and first coders of quantizer parameters identifying the codebooks and vectors used for coding the spectral coefficients of the sub-bands. A second coder processes supplemental information usable to improve, at a dequantizer, decoded spectral coefficients of the sub-bands. Corresponding multi-rate algebraic vector dequantizer and dequantizing method are also provided.

### PRIORITY CLAIM

This application claims benefit of U.S. Prov Appln Ser. No. 61/355,903 filed on Jun. 17, 2010, the specification of which is expressly incorporated herein by reference.

### FIELD

The present disclosure relates to a multi-rate algebraic vector quantizer and corresponding method for coding spectral coefficients of a plurality of sub-bands of an input spectrum, including coding of supplemental information.

### BACKGROUND

Features of the ITU-T G.722/G.711.1 superwideband (SWB) extension framework (also known as ITU-T Recommendation G.722 Annex B and ITU-T Recommendation G.711.1 Annex D) will be briefly described, in particular features of the monaural part of that ITU-T G.722/G.711.1 superwideband (SWB) extension framework.

The SWB extension framework comprises two core codecs. One of the core codec is a G.722 codec, and the other core codec is a G.711.1 codec. The SWB extension framework presents several operational capabilities:

1) The SWB capability for G.722 56 kbit/s core operates at 64 kbit/s.
2) The SWB capability for G.722 64 kbit/s core operates at 80 and 96 kbit/s.
3) The SWB capability for G.711.1 80 kbit/s core operates at 96 and 112 kbit/s.
4) The SWB capability for G.711.1 96 kbit/s core operates at 112 and 128 kbit/s.

The bitstream comprises several embedded layers. The 8 kbit/s SWB bit budget in case 1) is shared between EL0 (enhancement layer 0) with usually 19 bits and SWBL0 (SWB layer 0) with usually 21 bits. The first 16 kbit/s SWB bit budget in cases 2), 3) and 4) is shared between EL0, SWBL0 and SWBL1. SWBL1 (SWB layer 1) comprises 40 bits. The second 16 kbit/s SWB bit budget in cases 2), 3) and 4) is shared between EL1 (enhancement layer 1) with 40 bits and SWBL2 (SWB layer 2) with another 40 bits. The enhancement layers (EL0, EL1) are always G.722/G.711.1 core dependent while the SWB layers (SWBL0, SWBL1, SWBL2) are common for both core codecs.

The input signal of the two codecs is sampled at a sampling rate of 32 kHz with a bandwidth limited between 50 Hz and 14000 Hz. The input signal is divided by a quadrature mirror filter (QMF) into two 8-kHz-wide bands sampled at a sampling rate of 16 kHz. The lower 8-kHz-wide band is further subdivided by another QMF filter into two 4-kHz-wide bands sampled at a sampling rate of 8 kHz. The lower 4-kHz-wide band is called the lower-band (LB, 0-4 kHz), the higher 4-kHz-wide band is called the higher-band (HB, 4-8 kHz) and the higher 8-kHz-wide band is called super higher-band (SHB, 8-16 kHz).

The length of the frames is 5 ms which corresponds to 160 samples of the input signal processed in every frame. The HB signal in the G.711.1 core codec is transformed into the Modified Discrete Cosine Transform (MDCT) domain resulting in 40 HB MDCT spectral coefficients in every frame. These 40 HB MDCT spectral coefficients are coded by the G.711.1 core codec with attenuation on the last spectral coefficients (basically the 7-8 kHz frequency band is missing).

The SHB signal is processed the same way for both the G.722 and G.711.1 core codecs. The SHB signal is transformed into the MDCT domain resulting in 80 SHB MDCT spectral coefficients in every frame. In the processing of the SWB layers, 64 (out of 80) SHB MDCT coefficients corresponding to the 8-14.4 kHz frequency band are encoded. The remaining 16 MDCT coefficients corresponding to the 14.4-16 kHz frequency band are discarded. The 64 SHB MDCT coefficients are divided into 8 frequency sub-bands (sub-vectors) each with 8 spectral coefficients. The principal quantization technique used in the SWB extension framework is the algebraic vector quantization (AVQ). An example of conventional AVQ is described in the article [M. Xie and J.-P. Adoul, “Embedded algebraic vector quantization (EAVQ) with application to wideband audio coding,” IEEE International Conference on Acoustics, Speech, and Signal Processing (ICASSP), Atlanta, Ga., U.S.A, vol. 1, pp. 240-243, May 1996], of which the content is herein incorporated by reference.

The coding of the SHB signal is performed in three embedded layers, namely SWBL0, SWBL1 and SWBL2 with a bit budget of 21 bits, 40 bits and 40 bits, respectively. SWBL0 uses 2 bits to encode signal class such as harmonic, normal, noise, and transition, 5 bits to encode a global gain, and 14 bits to encode a normalized frequency envelope. The normalized frequency envelope represents a normalized-by-global-gain average spectral envelope in each of the 8 sub-bands. SWBL1 encodes coding mode information (1 bit), global gain adjustment (3 bits) and MDCT coefficients encoded using AVQ (36 bits). SWBL2 further encodes other MDCT coefficients using AVQ (40 bits). In a coding mode 0, AVQ is used to encode the original SHB coefficients; in a coding mode 1, AVQ is used to encode error SHB coefficients (non-negative difference between an absolute spectrum and an adjusted spectral envelope). There is also a special case, a coding mode 2, used in occasions of signal class switching and its processing is very similar to coding mode 0; in this case identification of the coding mode is derived from signal class information and is not transmitted in the bitstream.

### BRIEF DESCRIPTION OF THE DRAWINGS

In the appended drawings:

FIG. 1 is a schematic block diagram of an example of multi-rate vector quantizer with supplemental coding, more specifically coding of supplemental information;

FIG. 2A is a graph showing statistics of AVQ unused bits corresponding to layer SWBL1 coding, and FIG. 2B is a graph showing statistics of AVQ unused bits corresponding to layer SWBL2 coding;

FIG. 3A is a graph of an example of spectrum of an input signal showing the spectral envelope of the input signal; and FIG. 3B is a graph of an example of a per band-normalized spectrum of the same input signal;

FIG. 4 is a graph showing an effect of spectrum per-band normalization on the occurrence of particular quantizers for quantizing the input spectrum (left bar) and the per sub-band normalized input spectrum (right bar);

FIG. 5 is a graph showing a dependency between a global AVQ gain and a SWBL0 global gain;

FIG. 6 is a graph showing examples of problems in SHB spectrum, wherein curve 600 represents an input spectrum, curve 601 corresponds to a non-optimized output spectrum, and curve 602 corresponds to an optimized output spectrum;

FIG. 7 is a schematic block diagram of an example of classifier computing detection sub-flags f₁ and f₂;

FIG. 8 is a schematic block diagram describing the classifier of FIG. 7 computing detection counter c;

FIG. 9A is a flow chart of an example of method for coding the SHB spectrum for coding mode≠1; and FIG. 9B is a block diagram of an example of quantizer portion for coding the SHB spectrum for coding mode≠1;

FIGS. 10A-10E are schematic diagrams of an example of coding of the SHB spectrum in the G.722/G.711.1 SWB extension framework for coding mode≠1, wherein FIG. 10A is a SWB spectrum before the AVQ coding, FIG. 10B is a AVQ locally decoded spectrum, FIG. 10C is a base vector to be used for a correlation search, FIG. 10D represents the correlation search, and FIG. 10E is the reconstructed (optimized) spectrum;

FIG. 11A is a flow chart of an example of method for coding the SHB spectrum for coding mode 1; and FIG. 11A is a flow chart of an example of quantizer portion for coding the SHB spectrum for coding mode 1;

FIG. 12 are graphs representing an example of SHB MDCT spectrum of one frame; from top: input spectrum, AVQ coded spectrum, output spectrum (zero coefficients are replaced by the spectral envelope), optimized output spectrum;

FIG. 13 is a graph of examples of spectrums of several consecutive frames, wherein curve 130 corresponds to an input spectrum, curve 131 corresponds to a non-optimized output spectrum, and curve 132 corresponds to an optimized output spectrum;

FIG. 14 is a graph showing an example of the improvement in the SHB spectrum for G.722 core codec at 96 kbit/s achieved using detection of problematic zero sub-bands, wherein curve 140 corresponds to an input spectrum, curve 141 corresponds to an output spectrum, and curve 142 corresponds to an optimized output spectrum.

FIG. 15 is a graph showing an example of improvement in SHB spectrum for the G.722 core codec at 96 kbit/s achieved using better correlation match between original and reconstructed spectra, wherein curve 150 corresponds to an input spectrum, curve 151 corresponds to an output spectrum, and curve 152 corresponds to an optimized output spectrum;

FIGS. 16A-16D are schematic diagrams representing an example of coding in G711EL0, wherein most part of the HB spectrum (FIG. 16A) is coded by the G.711.1 core codec, a part of the spectrum to be enhanced in SWBL0 is shown in FIG. 16C where FIG. 16B is an average energy per coefficient of an error spectrum, and FIG. 16D represents an example of reconstructed spectrum when AVQ encodes the second sub-band and there are 4 AVQ unused bits; and

FIG. 17 is a graph showing an example of improvement in the HB spectrum, wherein curve 170 corresponds to an input spectrum, curve 171 corresponds to a reference output spectrum, and curve 172 corresponds to an optimized output spectrum.

### DETAILED DESCRIPTION

In accordance with an illustrative embodiment, there is provided a multi-rate algebraic vector quantizing method for coding spectral coefficients of a plurality of frequency sub-bands, comprising: quantizing the spectral coefficients of the sub-bands, quantizing the spectral coefficients comprising using a plurality of codebooks each including a plurality of vectors and coding quantizer parameters identifying the codebooks and vectors used for coding the spectral coefficients of the sub-bands; and coding supplemental information usable to improve, at a dequantizer, decoded spectral coefficients of the sub-bands.

In accordance with another illustrative embodiment, there is provided a multi-rate algebraic vector quantizer for coding spectral coefficients of a plurality of frequency sub-bands, comprising: a quantizer portion supplied with the spectral coefficients of the sub-bands, the quantizer portion having a plurality of codebooks each including a plurality of vectors, and first coders of quantizer parameters identifying the codebooks and vectors used for coding the spectral coefficients of the sub-bands; and a second coder of supplemental information usable to improve, at a dequantizer, decoded spectral coefficients of the sub-bands.

In accordance with a further illustrative embodiment, there is provided a multi-rate algebraic vector dequantizing method for decoding spectral coefficients of a plurality of frequency sub-bands, comprising: decoding received, coded quantizer parameters identifying codebooks and vectors of the codebooks used for coding the spectral coefficients of the sub-bands; decoding received, coded supplemental information usable to improve the decoded spectral coefficients of the sub-bands; and dequantizing the decoded quantizer parameters and the decoded supplemental information to produce the decoded spectral coefficients.

In accordance with a still further illustrative embodiment, there is provided a multi-rate algebraic vector dequantizer for decoding spectral coefficients of a plurality of sub-bands of a spectrum, comprising: first decoders of received, coded quantizer parameters identifying codebooks and vectors of the codebooks used for coding the spectral coefficients of the sub-bands; a second decoder of received, coded supplemental information usable to improve the decoded spectral coefficients of the sub-bands; and a dequantizer portion supplied with the decoded quantizer parameters and the decoded supplemental information and having an output for the decoded spectral coefficients.

The above and other features will become more apparent from the following non-restrictive description of illustrative embodiments given for the purpose of illustration only with reference to the accompanying drawings.

In the SWB extension framework, the HB signal in the G.711.1 core codec is transformed into the Modified Discrete Cosine Transform (MDCT) domain resulting in 40 HB MDCT spectral coefficients in every frame. These 40 HB MDCT spectral coefficients are coded by the G.711.1 core codec with attenuation of the last spectral coefficients (basically the 7-8 kHz frequency band is missing). The missing 7-8 kHz band in the G.711.1 core codec is coded in the SWB extension framework in the G.711.1 core EL0 layer further denoted as G711EL0. An optimization technique related to coding of the HB signal in G711EL0 will be described in the following Section 3.

The SHB signal is processed the same way for both the G.722 and G.711.1 core codecs. The SHB signal is transformed into the MDCT domain resulting in 80 SHB MDCT spectral coefficients in every frame. In the processing of the SWB layers, 64 (out of 80) SHB MDCT coefficients corresponding to the 8-14.4 kHz frequency band are encoded. The remaining 16 MDCT coefficients corresponding to the 14.4-16 kHz frequency band are discarded. The 64 SHB MDCT coefficients are divided into 8 sub-bands (sub-vectors) each with 8 spectral coefficients. The principal quantization technique used in the SWB extension framework is the algebraic vector quantization (AVQ). An optimization technique related to coding or the SHB signal is dealt with further in Section 2. For a description of the G.722/G.711.1-SWB codecs, reference is made to publications [ITU-T Recommendation G.711.1 Annex D, Geneva, Switzerland, November 2010] and [ITU-T Recommendation G.722 Annex B, Geneva, Switzerland, November 2010], of which the content is hereby incorporated by reference.

Given the available bit budget allocated to AVQ (36 bits in SWBL1 and 40 bits in SWBL2), the AVQ is able to encode a maximum of 3, respectively 4, sub-bands in SWBL1, respectively SWBL2. Thus in every frame there is at least one sub-band where AVQ is not applied or the AVQ quantized output vector is formed of zero spectral coefficients. These sub-bands are called “zero sub-bands” as the AVQ quantized output vector is zero for these sub-bands and can be processed differently using herein presented optimization techniques.

The actual bit budget used to encode AVQ indices in SWBL1 and SWBL2 varies from frame to frame and the difference between the allocated 36, respectively 40, bits and the actually used bits is called “AVQ unused bits”. The AVQ unused bits are further employed to refine the zero sub-bands. The zero sub-bands are reconstructed depending on coding mode and flag selection. When there are no AVQ unused bits in coding mode≠1, the zero sub-bands are replaced by the SWBL0 output spectrum that is derived from the LB+HB spectrum with adjusted energy envelope. The spectral coefficients of the SWBL0 output spectrum are almost random and do not match well the original SHB spectrum. This is especially true in spectra with dominant spectral peaks (i.e., when the maximum energy of a sample in the sub-band is substantial compared to the average energy in this sub-band). When there are no AVQ unused bits in coding mode 1, the zero sub-bands are replaced by the spectral envelope with the signs of the spectral coefficients corresponding to the signs of the SWBL0 output spectral coefficients (again, these signs are almost random). Consequently the fine structure of the SHB spectrum is lost. In coding mode 1, even the zero spectral coefficients in AVQ coded sub-bands are replaced by the spectral envelope with the signs of the spectral coefficients corresponding to the signs of the SWBL0 output spectral coefficients. When there are some AVQ unused bits available, the processing is different and described later with herein presented optimization techniques.

1. Multi-Rate Quantizer with Supplemental Coding

Techniques for optimizing AVQ in the G.722/G.711.1 SWB extension framework are related to the enhancement in SHB spectrum for both SWB codecs. Such techniques change SWBL1 and SWBL2 related bitstream and affect quality in G.722 at 96 kb/s and in G.711.1 at 112 kb/s. Further an optimization of HB spectrum for the G.711.1 core codec is presented which changes the G711EL0 quality and bitstream. These optimization techniques are described separately in the following Sections 2.5. 2.6, 2.7 and 3.2, but they are all based on coding supplemental information in the bitstream using a multi-rate algebraic vector quantizer with coding of supplemental information. Also some additional optimization techniques used in the G.722/G.711.1 SWB extension framework are presented in the following Sections 2.1, 2.2 and 2.8.

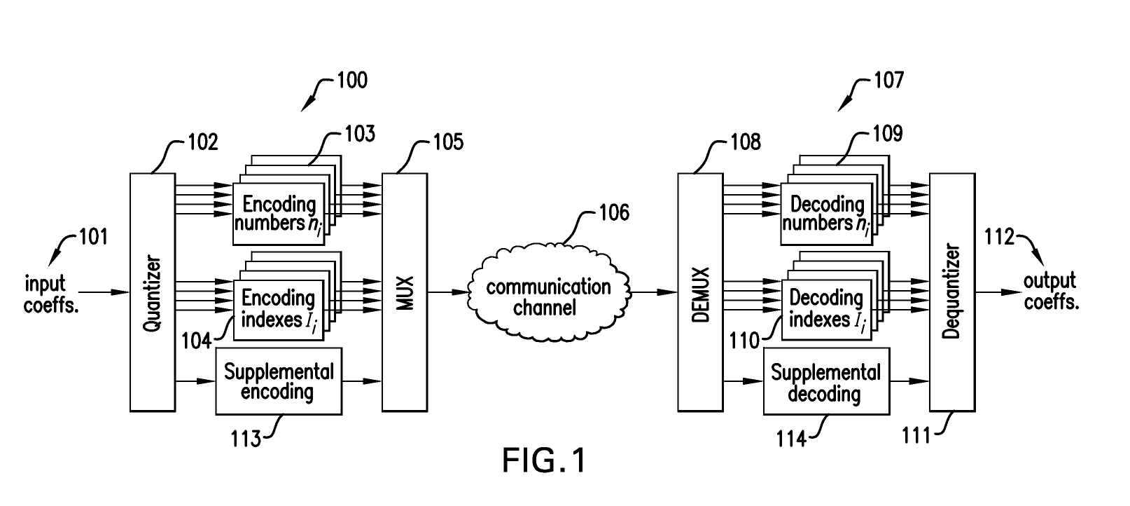

On the transmitter side, AVQ is performed by a multi-rate algebraic vector quantizer 100 as illustrated in FIG. 1. In the illustrated example, the multi-rate algebraic vector quantizer 100 codes spectral coefficients 101 of the sub-bands of the input spectrum with a different number of bits (i.e. with a different bit rate). An example of conventional multi-rate algebraic vector quantizer is described in the article [S. Ragot, B. Bessette, and R. Lefebvre, “Low-Complexity Multi-Rate Lattice Vector Quantization with Application to Wideband TCX Speech Coding at 32 kbit/s,” Proc. IEEE ICASSP, Montreal, QC, Canada, vol. 1, pp. 501-504, May 2004], of which the content is herein incorporated by reference.

Referring to FIG. 1, the multi-rate algebraic vector quantizer 100 includes a quantizer portion 102 which quantizes the input spectral coefficients 101 representative of the various frequency sub-bands with a different number of bits (i.e. with a different bit rate). The quantizer portion 102 comprises a plurality of codebooks (not shown) identified by respective numbers nᵢ and associated with respective sub-bands of the input spectrum. Each codebook of the quantizer portion 102 contains a plurality of vectors identified by respective indexes Iᵢ. Therefore, the codebook numbers nᵢ and the vector indexes Iᵢ describe the quantizer parameters in each sub-band i. Coders 103 and 104 code the quantizer parameters identifying the codebooks and vectors used for coding the spectral coefficients of the sub-bands, including the codebook numbers nᵢ and the vector indexes Iᵢ, respectively, in the respective sub-bands i. A multiplexer 105 combines the coded quantizer parameters, more specifically the coded codebook numbers nᵢ and vector indexes Iᵢ for transmission through a communication channel 106.

Still referring to FIG. 1, on the receiver side, there is provided a multi-rate algebraic vector dequantizer 107 for decoding the spectral coefficients of the sub-bands of the spectrum. The multi-rate algebraic vector dequantizer 107 comprises a demultiplexer 108 for demultiplexing the received coded quantizer parameters identifying the codebooks and vectors of these codebooks used for coding the spectral coefficients, these quantizer parameters including the codebook numbers nᵢ and vector indexes Iᵢ transmitted through the communication channel 106. Decoders 109 and 110 decode the demultiplexed coded codebook numbers nᵢ and vector indexes Iᵢ, respectively, in the respective sub-bands i. A dequantizer portion 111 is supplied with the decoded codebook numbers nᵢ and vector indexes Iᵢ and uses the respective codebooks and vector indexes to dequantize and produce on an output decoded output spectral coefficients 112 corresponding to the input spectral coefficients 101.

The bit-budget available for the AVQ coding is set as a maximum number of bits to be used to encode the input spectral coefficients 101. However the maximal bit-budget is not always completely consumed. There are frames where a number of bits smaller than the maximum number of bits is used to encode the input spectral coefficients 101 and the rest of the bits remain unused. Also, coding of the zero sub-bands in last sub-bands of the input spectral coefficients 101 can be omitted. Therefore a bitstream packing can be rewritten to detach the AVQ unused bits from the bitstream with no impact on the quantization result.

Therefore, by rewriting the code, some bits, complexity, memory and length of the code can be saved. The AVQ unused bits in relevant frames can be used for another purpose. This leads to a multi-rate quantizer 100 (FIG. 1) with supplemental coding, more specifically with a coder 113 of supplemental information usable to improve, at the dequantizer 107, decoded spectral coefficients of the sub-bands. The supplemental information is quantized in the quantizer portion 102, coded in the coder 113 and multiplexed with the coded codebook numbers nᵢ and vector indexes Iᵢ in the multiplexer 105 for transmission through the communication channel 106.

On the receiver side, the demultiplexer 108 demultiplexes the received supplemental information and the received coded quantizer parameters identifying the codebooks and vectors of these codebooks used for coding the spectral coefficients, these quantizer parameters including the codebook numbers nᵢ and vector indexes Iᵢ transmitted through the communication channel 106. As described hereinabove, the decoders 109 and 110 decode the demultiplexed coded codebook numbers nᵢ and vector indexes Iᵢ, respectively, in the respective sub-bands i. A decoder 114 decodes the supplemental information from the demultiplexer 108. Finally, the dequantizer portion 111 dequantizes received coded codebook numbers nᵢ, vector indexes Iᵢ and supplemental information to produce the decoded output spectral coefficients 112 corresponding to the quantized input spectral coefficients 101.

In general, the supplemental information that is coded can be used in a number of ways. The herein disclosed techniques focus on structuring the supplemental information for improving the AVQ zero sub-bands. In the G.722/G.711.1 SWB extension framework, this can be achieved basically by three different optimization techniques presented in the following description (two optimization techniques for SHB, one optimization technique for HB). Obviously, these optimization techniques are used where applicable, i.e. only in frames with a non-zero number of AVQ unused bits.

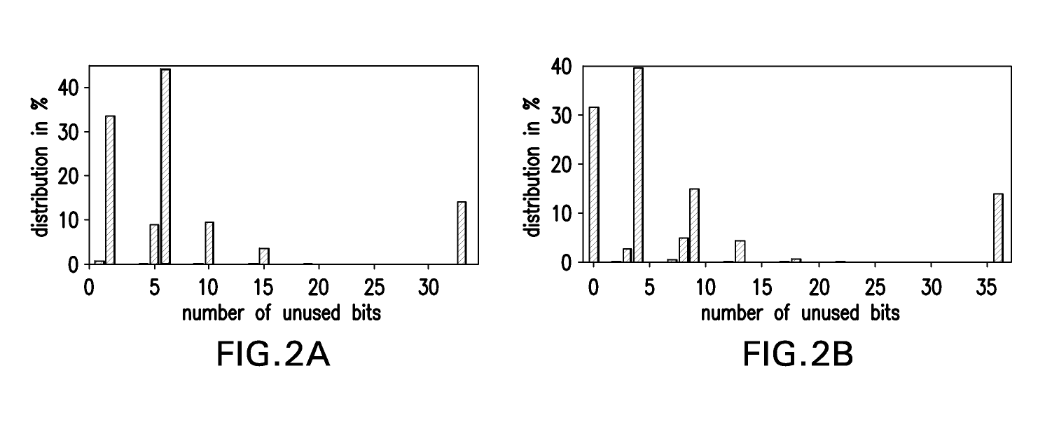

Statistics of the AVQ unused bits in the G.722/G.711.1 SWB extension framework in SWBL1 (36 bits reserved for the AVQ) and SWBL2 (40 bits reserved for the AVQ) are shown in FIG. 2. A 3-minute database of speech, mixed content and several genres of music after excluding zero input signals was used and the coding mode was always set to coding mode 0. The graphs of FIGS. 2A and 2B show that all available bits are used by the AVQ in about only 1% and 32% of the frames for SWBL1 and SWBL2, respectively.

There is a number of different ways how to employ the AVQ unused bits. For example, they can be used to transmit additional Frame Error Concealment (FEC) information in the bitstream in relevant frames.

### 2. Optimization Techniques in SHB Used in the Two SWB Codecs

The first step in coding the SHB signal in the MDCT domain S_{SHB}(k) is the normalization. The quantized global gain ĝ_{glob} computed and transmitted in layer SWBL0 is used to obtain the normalized spectrum:

S(k)=S_{SHB}(k)/ĝ_{glob}, k=0, . . . , (M*N)−1,

where N is the number of SHB sub-bands and M the number of spectral coefficients in each sub-band. For example, in the G.722/G.711.1 SWB extension framework N=8 and M=8. Similarly, the quantized spectral envelope computed and transmitted in layer SWBL0 is normalized by the quantized global gain ĝ_{glob} which results in the quantized, normalized spectral envelope \hat{f}ₑₙᵥ(i), i being the sub-band number that holds i=0, . . . , N−1.

The optimization techniques presented in this section are related to layers SWBL1 and SWBL2 that are common for both SWB codecs of the SWB extension framework.

### 2.1 Per Sub-Band Normalization

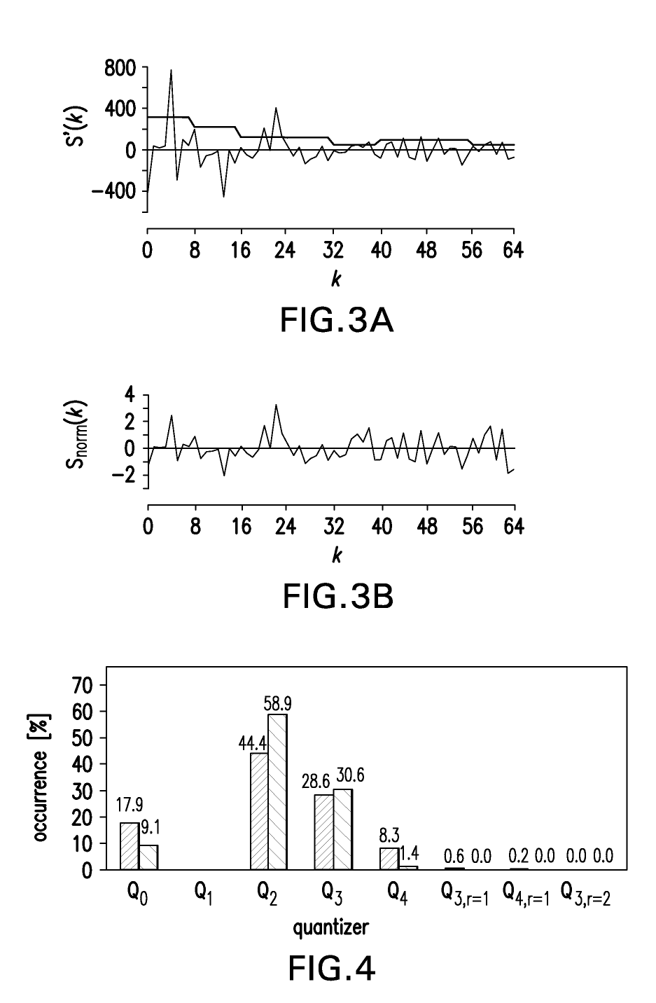

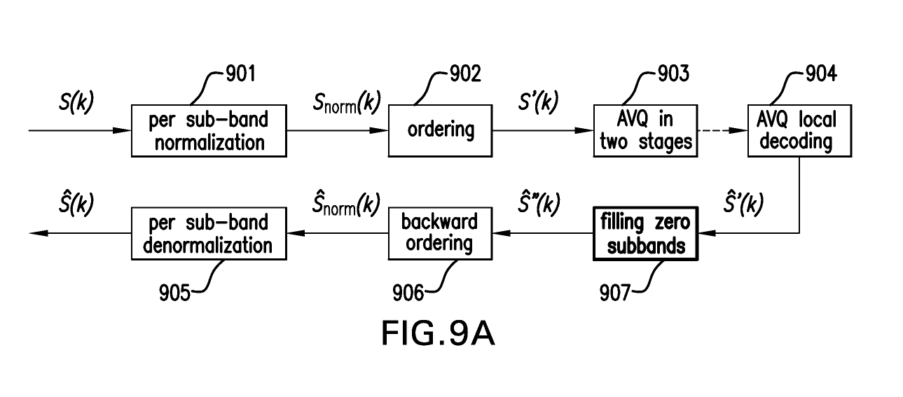

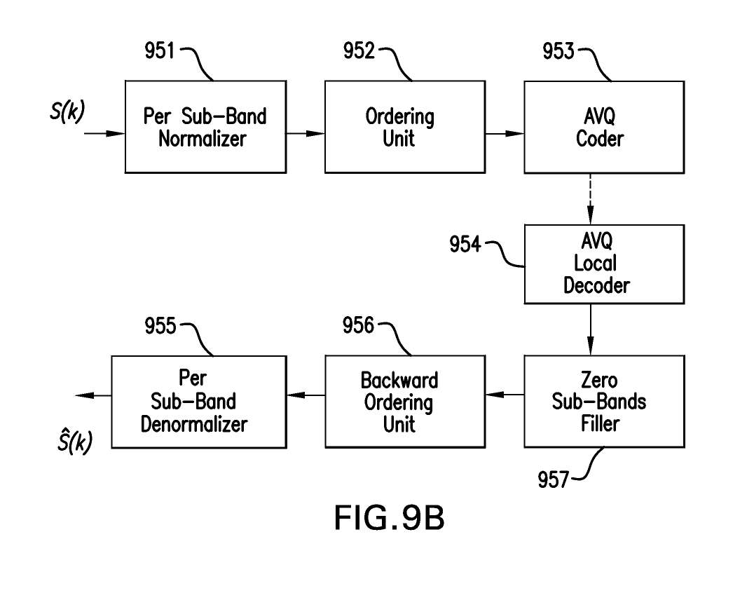

Before performing the AVQ, the quantizer portion 102 comprises a per-sub-band normalizer 951 (FIG. 9B) to normalize the input spectrum S(k) to be quantized per sub-band (operation 901 of FIG. 9A) using the spectral envelope information from layer SWBL0. In this manner, the spectrum is made as flat as possible. The AVQ is then able to encode more sub-bands because the AVQ codebook numbers nᵢ differ less from sub-band to sub-band than is the case for a non-normalized spectrum. Thus we reduce the cases where a small number of sub-bands needs to be coded by AVQ sub-quantizers Qₙ_{ᵢ} with a high AVQ codebook number nᵢ (and a high bit-budget) while the remaining sub-bands are coded by the AVQ sub-quantizer Q₀ (zero sub-bands). This is illustrated in FIGS. 3 and 4.

The quantizer portion 102 also comprises an ordering unit 951 (FIG. 9B) to order the spectrum to be quantized per sub-bands (operation 902 of FIG. 9A) using vector ord_b(i). The vector ord_b(i) contains indexes for each sub-band such that the ord_b(i)-th sub-band corresponds to the (i+1)-th highest perceptual importance among all sub-bands. Consequently the sub-bands are sorted by decreasing perceptual importance that is advantageous for choosing the most perceptually important sub-bands to be coded in SWBL1 while the less perceptually important sub-bands coded in SWBL2 in the AVQ (see further in Section 2.2). Finally, the whole spectrum is divided by the constant β that helps the AVQ to properly deal with low energy MDCT coefficients (for details see Section 2.2). The spectrum to be quantized is computed in one step using the following relation:

$${S}^{′} ( i * M + j ) = \frac{S ( ord\_b ( i ) * M + j )}{β * {\hat{f}}_{env} ( ord\_b ( i ) )} , \\ i = 0 , … , N - 1 , j = 0 , … , M - 1$$

The spectrum S′(i*M+j) contains spectral coefficients to be AVQ-quantized with the most perceptually important sub-band corresponding to i=0 and the less perceptually important sub-band corresponding to i=N−1. The AVQ can be thus used sequentially with a limited number of spectral sub-bands as an input and ensures coding of the most perceptually important sub-bands and saves computational complexity at the same time. The sequential AVQ coding is advantageous in scalable codecs with several embedded layers.

### 2.2 Sequential AVQ Coding

Encoding of the SHB signal is based on quantization of the normalized and ordered spectrum S′(k) using the AVQ. The AVQ coding (operation 903 of FIG. 9A) is made by an AVQ coder 953 (FIG. 9B) in two stages that correspond to the coding of the content of layers SWBL1 and SWBL2. Given the available bit-budget allocated for the AVQ (36 bits in layer SWBL1 and 40 bits in layer SWBL2), the AVQ is able to encode maximally 3, respectively 4, sub-bands in layer SWBL1, respectively SWBL2. Thus at least one sub-band remains a zero sub-band. In practice, the number of zero sub-bands is often higher in the SWB extension framework: measured on a 3-minute database after excluding the zero input signals, there are 22% of the frames with one zero sub-band, 56% of the frames with two zero sub-bands, 21% of the frames with three zero sub-bands, and 1% of the frames with more than three zero sub-bands. A possibly different bit-budget corresponding to embedded layers and even a higher number of embedded layers will not limit the general use of the technique described herein. It is interesting to notice that the AVQ in SWBL1 quantizes the first three most perceptually important sub-bands while the four sub-bands AVQ quantized in SWBL2 always correspond to the four most perceptually important sub-bands not quantized in SWBL1. If there remains only one zero sub-band after the SWBL1 and SWBL2 quantization, it is always the least perceptually important one. If there remain more zero sub-bands, they are usually the least perceptually important ones (at least one of them is the least perceptually important one).

The AVQ in layer SWBL1 returns three quantized sub-bands Ŝ′(i*M+j), i=0, 1, 2, and j=M−1. If none of these sub-bands are zero sub-bands (i.e. none of the quantized sub-bands contain zero spectral coefficients only), the input spectrum for the SWBL2 AVQ coding comprises four sub-bands S′(i*M+j), i=3, 4, 5, 6. If one or two SWBL1 output sub-bands are zero sub-bands, these zero sub-bands are placed at the first positions of the input spectrum for the SWBL2 AVQ coding. Consequently the AVQ computed in SWBL2 returns spectral coefficients of four quantized sub-bands that are joined to the output quantized spectral coefficients from SWBL1 and form the AVQ locally decoded spectrum Ŝ′(i*M+j), i=0, . . . , N−1. The remaining Ŝ′(i*M+j) coefficients that are not coded using the AVQ neither in layer SWBL1 nor layer SWBL2 are replaced by zero MDCT coefficients and form also the zero sub-bands. The spectrum Ŝ′(k) that contains at least one zero sub-band is subject to filling using the procedure described further in Section 2.7.

### 2.3 Correlation Between the Global Gain and the Global AVQ Gain

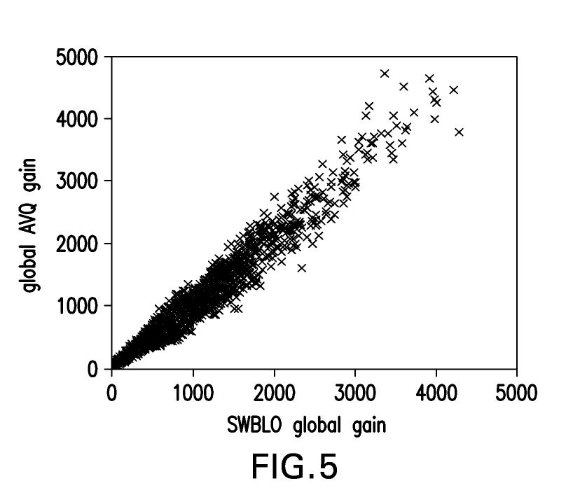

The last step of the AVQ coding usually comprises computing the global AVQ gain. However, this is not done in the SWB extension framework since the quantized global gain transmitted in layer SWBL0 is employed instead. There is a high correlation between the SWBL0 global gain and the global AVQ gain as shown in FIG. 5. For that reason it is better not to compute and quantize the global AVQ gain and save some bit budget. On the other hand, the energy of the spectrum after per sub-band normalization (Section 2.1) is too low due to the quantization error in some cases. Therefore the whole spectrum can be divided by a constant to help the AVQ to quantize the spectrum and not replace it by zeros. The constant that helps to encode low energy spectrums is set in the SWB extension framework to β=10⁻³.

### 2.4 Techniques Used in SHB

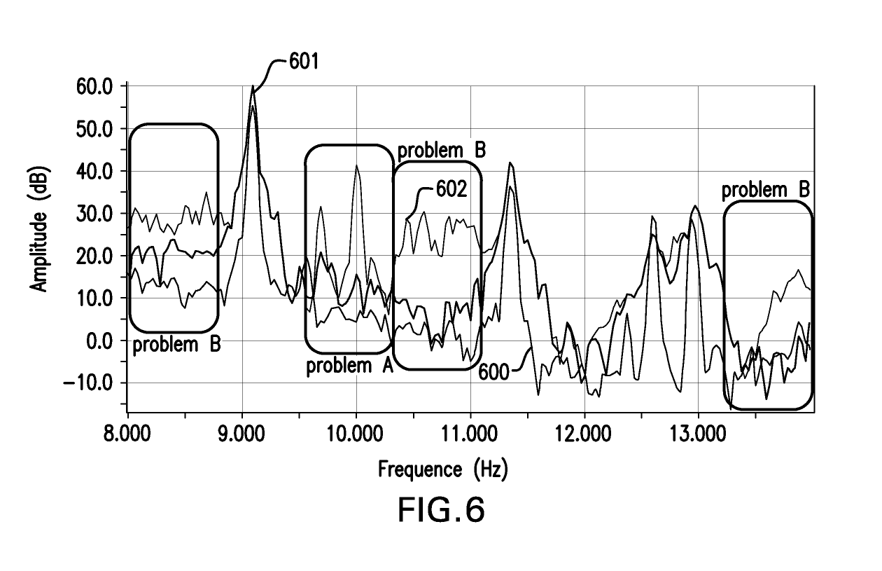

To form the full coded SHB spectrum, the spectral coefficients in the AVQ zero sub-bands are determined as well. If none of the presented optimization techniques is used and coding mode≠1, the spectral coefficients in the zero sub-bands are replaced by the SWBL0 output spectrum. Note that the SWBL0 output spectrum is derived from the LB+HB spectrum with adjusted frequency envelope only where the frequency envelope is known from the SWBL0 bit-stream and the particular adjustment depends on the signal class. Thus the filling of zero sub-bands is very limited and the accuracy of the zero sub-bands representation suffers. There is a weak correlation of the input spectrum and the reconstructed spectrum in zero sub-bands, especially in case of sub-bands with dominant spectral peaks. Moreover energy problems occur. This is illustrated in FIG. 6.

The problem A in FIG. 6 is caused because the zero sub-band in the SWBL2 spectrum is filled using the SWBL0 output spectrum. As the SWBL0 output spectrum is derived from the LB+HB spectrum that contains strong peaks, these peaks are transformed to the SHB spectrum. The problems B in FIG. 6 are caused by wrong energy estimation in zero sub-bands reconstruction caused by limitations in the frequency envelope quantization. The sub-bands with wrong energy estimation are further called “problematic zero sub-bands”.

As mentioned in Section 1, the AVQ unused bits in relevant frames can be used to improve the codec performance. In SHB, the AVQ unused bits can be used for improving the zero sub-bands when full bit-rate is received (i.e. the highest bit-rate is received). The improvement is based on two different techniques.

The first technique is based on detection of frames with problematic zero sub-bands. The detection is different for different coding modes. For coding mode≠1, detection is made of frames where zero sub-bands do not contain any significant MDCT coefficients and where the SHB spectral envelope coding is likely to be very inaccurate. The above classification (frames with problematic zero sub-bands) is based also on the AVQ features as described in Section 2.5. This is a 1-bit classification sent to the dequantizer when there is at least one AVQ unused bit in layer SWBL1 (in 99% of the cases, see FIG. 2A). In the reconstructed spectrum, SHB zero sub-bands are filled using an adjusted spectral envelope attenuated (multiplied) by an attenuation factor γ. In the G.722/G.711.1-SWB framework, it is set to γ=0.1. Annoying artefacts transformed to the SHB spectrum from the LB+HB spectrum are thereby suppressed. A more detailed description is found in Section 2.5. A different classification (frames with problematic zero sub-bands) is used for coding mode 1 where detection of non optimal frequency envelope encoding is performed and a spectral envelope correction factor is computed and sent as 1- or 2-bit information (see Section 2.6).

The second technique is used when a frame is not classified as problematic in coding mode≠1, or in every case for coding mode 1. To better match both the original spectrum energy and the distribution of amplitudes of the MDCT coefficients, the zero sub-band coefficients are derived from the AVQ coefficients using a correlation. A maximum correlation lag (4 bits in the G.722/G.711.1 SWB extension framework) is sent to the dequantizer when a sufficient number of AVQ unused bits is available. This technique is applied in two zero sub-bands, one lag is sent in layer SWBL1 and the other lag in layer SWBL2 when AVQ unused bits are available. This technique is related to all coding modes.

These two techniques are used only when both layers SWBL1 and SWBL2 are received (although supplemental information can be encoded in both layers SWBL1 and SWBL2).

2.5 Detection of Frames with Problematic Zero Sub-Bands in Coding Modes≠1

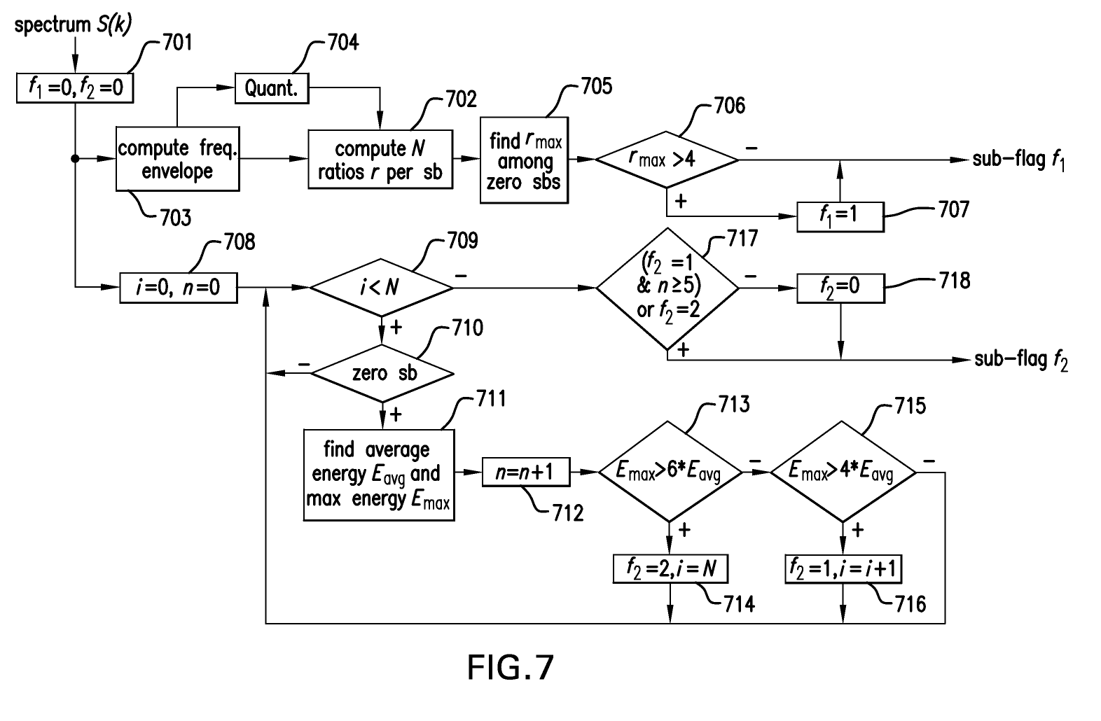

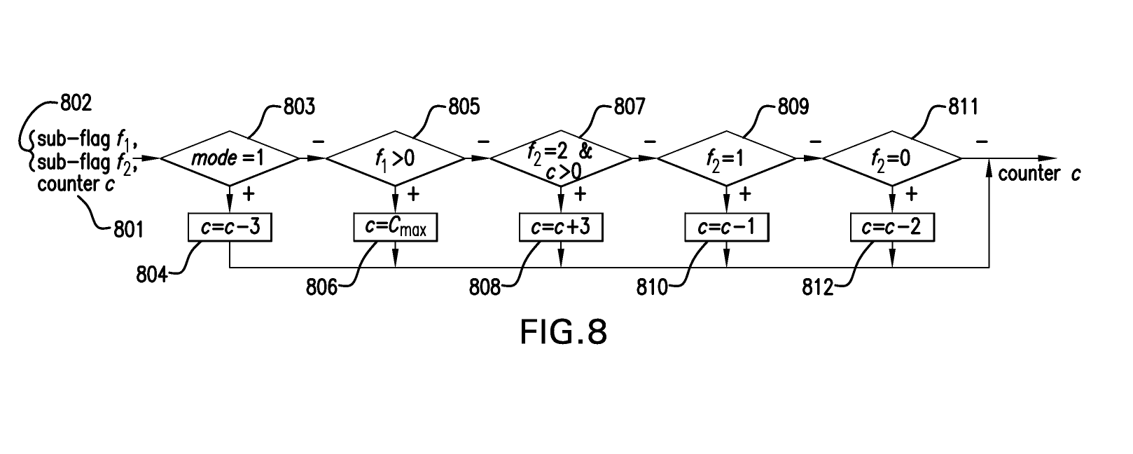

A classifier (FIGS. 7 and 8) is used to detect problematic zero sub-bands, i.e. sub-bands whose reconstruction is anticipated to be inaccurate in coding mode≠1. The classifier is based on detection of zero sub-bands where the spectral envelope is not quantized too close to its original (high quantization error in SWBL0 encoding). At the same time, distribution of energy in zero sub-bands is tested.

The following assumption is made: If a sub-band contains a peak (the energy of the maximum sample in the sub-band is substantial compared to the average energy in this sub-band), the coding of such sub-band should be covered by the AVQ. But if this sub-band is not covered by the AVQ (i.e. the sub-band is a zero sub-band) and the AVQ prefers other sub-bands (usually with peaks) to be encoded, this zero sub-band has a low importance. If there is a high number of such zero sub-bands, the zero sub-bands in the reconstructed spectrum can be filled with zeros or with an attenuated spectral envelope. In other words, if the AVQ codes only a small number of sub-bands with peaks, the others can be supposed as only little important ones and it is safer to fill these sub-bands with low energy coefficients than with the inaccurate SWBL0 output coefficients.

The following detection of problematic zero sub-bands is used only for frames with coding mode≠1. The detection itself relies on the value of a detection counter c (FIG. 8), c=0, . . . , Cₘₐₓ, that is updated on a frame basis. In the G.722/G.711.1 SWB extension framework, Cₘₐₓ is set to 20. If counter c>0, the detection flag for the current frame is f_{zd}=1, otherwise it is f_{zd}=0. The switch of the detection flag f_{zd} from one state to the other is allowed only in frames with unused AVQ bits (when the value of detection flag f_{zd} can be transmitted to the decoder). This keeps the synchronization of the quantizer and the dequantizer. In a frame with no AVQ unused bits, the value of the detection flag corresponds to its value in the previous frame.

The value of the detection counter c (FIG. 8) in the current frame depends on its value in the previous frame (detection counter c 801), on the coding mode and also on two detection sub-flags f₁ and f₂ (see 802 in FIG. 8). The value of the sub-flag f₁ can be 0 or 1 and depends on the detection of the inaccurate quantized spectral envelope in one of the zero sub-bands in the current frame.

Referring to FIG. 7, the input spectrum S(k) is first supplied to the classifier. The sub-flag f₁ is also initialized to 0 (operation 701). The following ratio is computed in operation 702 for each sub-band i:

$$r ( i ) = \frac{{\hat{f}}_{env} ( i ) - {f}_{env} ( i )}{{f}_{env} ( i )} , i = 0 , … , N - 1 ,$$

where fₑₙᵥ(i) is the normalized spectral envelope calculated in operation 703 for sub-band i, \hat{f}ₑₙᵥ(i) is a quantized representation (calculated in operation 704) of the normalized spectral envelope known from SWBL0 coding and N is the number of sub-bands. Then a maximum ratio rₘₐₓ is searched in operation 705 within the zero sub-bands. If rₘₐₓ>4 (operation 706), f₁=1 (operation 707), otherwise f₁=0.

The value of the sub-flag f₂ can be 0, 1 or 2 and depends on the distribution of energy in the zero sub-bands. Initially the sub-flag f₂ is set to f₂=0 (operation 701). In the same manner, the values i and n are initialized to zero (operation 708). Then, if i<N (operation 709) and the current sub-band is a zero sub-band (operation 710), energy Eₘₐₓ of the maximum energy coefficient and average energy E_{avg} of all the spectral coefficients in each zero sub-band are found (operation 711). n is incremented by 1 (operation 712) and energy Eₘₐₓ is compared to average energy E_{avg}. If Eₘₐₓ>6*E_{avg} (operation 713), then sub-flag f₂ is set to 2 and i is set to N (operations 714 and 717). If Eₘₐₓ is not larger than 6*E_{avg} (operation 713) but Eₘₐₓ>4*E_{avg} (operation 715), f₂ is set to 1 and i is incremented by 1 (operation 716). The sub-flag f₂ is computed until it holds f₂=2 or all zero sub-bands are searched (operation 709 and 710).

When all the sub-bands have been searched (operations 709 and 710) and it has not been found that sub-flag f₂=2 (operation 714 and 717):

if sub-flag f₂=1 and n≧5 have been found (operations 712 and 716), then sub-flag f₂ remains set to 1 (operation 717); and

if neither sub-flags f₂=1 (operation 716) and sub-flags f₂=2 (operation 714) are found, sub-flag f₂ is set to 0 (operations 717 and 718).

The update of the detection counter c is performed as shown in FIG. 8. If mode=1 (operation 803), detection counter c is decremented by 3. If mode≠1 (operation 803) and sub-flag f₁>0 (operation 805), detection counter c is set to Cₘₐₓ (operation 806). If mode≠1 (operation 803), sub-flag f₁ is not larger than 0 (operation 805), and sub-flag f₂=2 and detection counter c>0, detection counter c is incremented by 3 (operation 808). If mode≠1 (operation 803), sub-flag f₁ is not larger than 0 (operation 805), and sub-flag f₂=1 (operation 809), detection counter c is decremented by 1 (operation 810). If mode≠1 (operation 803), sub-flag f₁ is not larger than 0 (operation 805), and sub-flag f₂=0 (operation 811), detection counter c is decremented by 2 (operation 812).

The updated value of the detection counter c is also checked in each frame to be in the defined range [0, Cₘₐₓ].

The detection flag f_{zd} is transmitted to the dequantizer as supplemental information if there is at least one AVQ unused bit in layer SWBL1. If f_{zd}=1 (and coding mode≠1), all zero sub-bands in the reconstructed SHB spectrum in a particular frame are filled by the dequantizer portion 111 (FIG. 1) using an attenuated spectral envelope with a sign corresponding to the sign of the SWBL0 output spectral coefficient. In the SWB extension framework, the spectral envelope is attenuated (multiplied) by an attenuation factor γ=0.1. But keeping the zero sub-band spectral coefficients zeroed is advantageous as well. If the detection flag f_{zd}=0, all zero sub-bands are replaced in the dequantizer portion 111 (FIG. 1) by original SWBL0 output spectral coefficients, or filled by spectral coefficients derived from the AVQ coded spectral coefficients (see another optimization technique in Section 2.7).

2.6 Detection of Frames with Problematic Zero Sub-Bands in Coding Mode 1

Another classifier (not shown) is used to detect problematic zero sub-bands in coding mode 1. In this coding mode, MDCT coefficients to be quantized are classified as being non sparse and the error MDCT spectrum is quantized by the AVQ. Similar to the technique described in Section 2.5, a detection of zero sub-bands where the spectral envelope is not quantized too close to its original is performed. But in coding mode 1, a distribution of energy in the zero sub-bands is not tested.

Similar to Section 2.5, the following ratio is computed at the coder:

$$r ( i ) = \frac{{\hat{f}}_{env} ( i ) - {f}_{env} ( i )}{{f}_{env} ( i )} , i = 0 , … , N - 1 ,$$

where fₑₙᵥ(i) is the normalized spectral envelope, \hat{f}ₑₙᵥ(i) is the quantized representation of this normalized spectral envelope known from SWBL0 coding and N=8 is the number of sub-bands. Then a maximum ratio rₘₐₓ is searched within the zero sub-bands and quantized using a 1- or 2-bit quantizer. The number of quantization levels depends on the number of AVQ unused bits.

Let f_{prob} be the detection flag with value depending on the value of rₘₐₓ according to the following conditions:
if (rₘₐₓ>8.0) f_{prob}=3
else if (rₘₐₓ>4.0) f_{prob}=2
else if (rₘₐₓ>2.0) f_{prob}=1
   else f_{prob}=0

The 2-bit detection flag is sent in the SWBL1 bitstream in coding mode 1 frames if there exist AVQ unused bits. If there are no AVQ unused bits, the flag f_{prob} is supposed to be 0. If there is only one AVQ unused bit and f_{prob}>1, the flag f_{prob} is reduced to 1 and its 1-bit value is sent to the dequantizer. The same reduction is done when there are (R₁+1) AVQ unused bits, R₁ being a number of bits in layer SWBL1 used to encode the maximum correlation lag in the technique described later in Section 2.7.

The difference between processing the SHB spectrum in different coding modes is that even in the case problematic frames are detected in coding mode 1, the technique from Section 2.7 is performed. In case of problematic frames in coding mode≠1, the technique from Section 2.7 is not performed.

When reconstructing the SHB spectrum in the dequantizer portion 111 (FIG. 1), the value of flag f_{prob} is used to correct the spectral envelope in all the zero sub-bands as follows:

\hat{f}ₑₙᵥ(i)=2^{-f}^{_{prob}}·\hat{f}ₑₙᵥ(i)

where \hat{f}ₑₙᵥ(i) is the decoded, quantized normalized spectral envelope for all i corresponding to the zero sub-bands.

2.7 Filling of Zero Sub-Bands with AVQ Coded Coefficients in all Coding Modes

Instead of filling the zero sub-bands with SWBL0 almost random output spectrum (coding mode≠1) or spectral envelope (coding mode 1), the zero sub-bands are filled in the dequantizer portion 111 (FIG. 1) with coefficients derived from the AVQ coded spectral coefficients from AVQ non-zero sub-bands. In this manner, a better match between the original spectrum and the reconstructed spectrum is achieved especially for sub-bands with significant peaks. (Note: it is possible to fill zero sub-bands with spectral coefficients derived from a LB+HB spectrum. But it is not used in the SWB extension framework.)

The technique for searching the best spectral coefficients to fill a zero sub-band differs slightly according to the coding mode. The case of coding mode≠1 is first described. In coding mode≠1, the technique is used only when a problematic frame is not detected (see Section 2.5). The corresponding coding of the SHB spectrum is shown in FIG. 9.

Referring to FIGS. 9A and 9B, in operation 901 of FIG. 9A, the input spectrum S(k) is per-band normalized in a per sub-band normalizer 951 (FIG. 9B) to produce the per-band normalized spectrum Sₙₒᵣₘ(k) (see Section 2.1). In operation 902 of FIG. 9A, the sub-bands of the per-band normalized spectrum Sₙₒᵣₘ(k) are ordered in an ordering unit 952 (FIG. 9B) to produce the ordered spectrum S′(k) (see Section 2.1). The per sub-band normalized and ordered spectrum S′(k) is then subjected to AVQ in two stages, the first stage corresponds to the AVQ in SWBL1 and the other stage corresponds to the AVQ in SWBL2 (operation 903 of FIG. 9A; see Section 2.2) in an AVQ coder 953 (FIG. 9B) and subsequently submitted to AVQ local decoding (operation 904 of FIG. 9A) in an AVQ decoder 954 (FIG. 9B) to form a quantized spectrum Ŝ′(k).

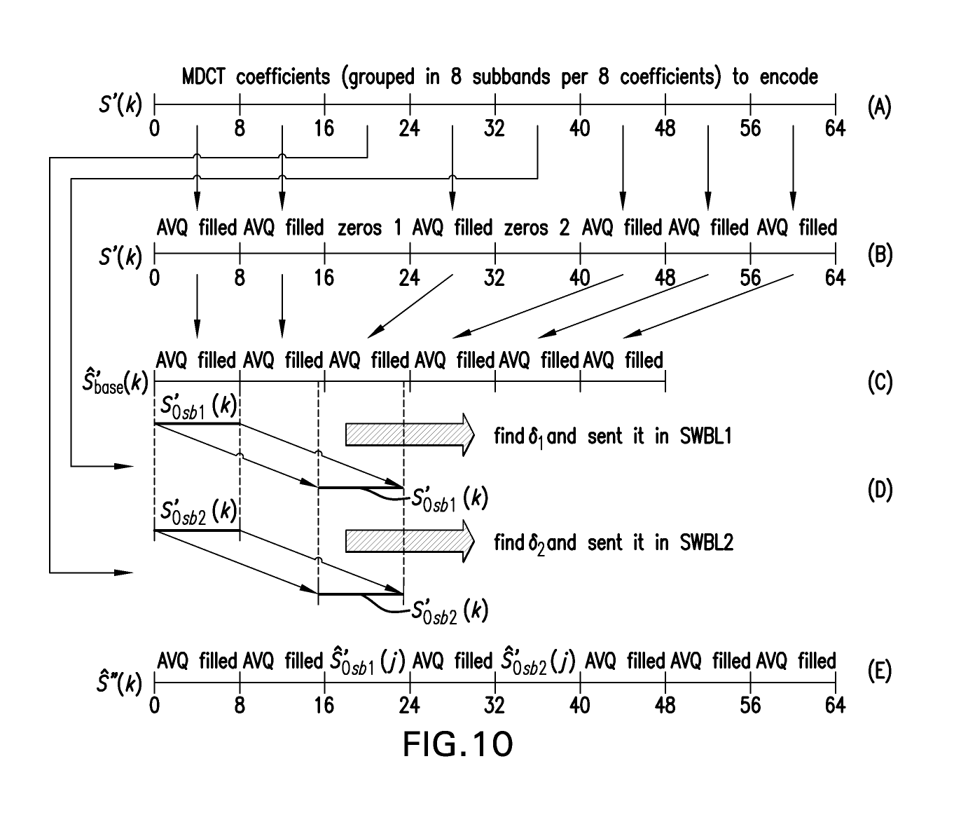

In the quantized spectrum Ŝ′(k), a zero sub-band filler 957 fills the zero sub-bands to form spectrum Ŝ″(k). The zero sub-band filler 957 (FIG. 9B) comprises a searcher (not shown) to conduct a search for the best spectral coefficients to fill a particular zero sub-band (operation 907) that is based on finding a maximum correlation between the original per sub-band normalized (operation 901) and sub-band ordered (operation 902) spectrum S′(k) in a zero sub-band and the spectrum Ŝ′_{base}(k) referred further as a “base spectrum”. The base spectrum Ŝ′_{base}(k) is extracted from the AVQ locally decoded (operation 904) spectrum Ŝ′(k) such that the zero sub-bands of Ŝ′(k) are omitted (see for example FIG. 10C). Thus the length of the spectrum Ŝ_{base}(k) is N_{base}*M, N_{base} being the number of non-zero sub-bands in the spectrum Ŝ′(k), wherein N_{base}<N−1.

Let us define a M-dimensional vector S′_{0sb1}(j), j=0, . . . , M−1, that corresponds to the spectral coefficients of the spectrum S′(k) in the first zero sub-band. Similarly a vector S′_{0sb2}(j) corresponds to the coefficients of the spectrum S′(k) in the second zero sub-band (if it exists). Giving the fact that sub-bands are ordered (operation 902) according to their perceptual importance, the vectors S′_{0sb1}(j) and S′_{0sb2}(j) represent the S′(k) spectrum coefficients of the two perceptually most important sub-bands not coded by the AVQ.

Let further Δₘₐₓ₁ be a maximum lag used in the correlation search for the first zero sub-band. Its value is Δₘₐₓ₁=2^{R}^{₁}−2, R₁ being a number of bits in layer SWBL1 used to encode the lag that corresponds to the maximum correlation. Similarly, Δₘₐₓ₂=2^{R}^{₂}−2 is the maximum lag used in the correlation search for the second zero sub-band, R₂ being a number of bits in layer SWBL2 used to encode the lag that corresponds to the maximum correlation. Values of Δₘₐₓ₁ and Δₘₐₓ₂ also affect the minimum length N_{base}*M of the base vector Ŝ′_{base}(k) that is greater than Δₘₐₓ₁+M and Δₘₐₓ₂+M, respectively.

Finally, if N_{base}*M>Δₘₐₓ₁+M, the 1-bit detection flag f_{zd}=0 and there is at least (R₁+1) AVQ unused bits in layer SWBL1 (note that 1 bit indicates the flag f_{zd}), the maximum correlation Rₘₐₓ₁ between the base spectrum Ŝ′_{base}(k) and the vector S′_{0sb1}(j) is searched as follows:

$${R}_{m ax 1} = {max}_{i} {\sum }_{j = 0}^{M - 1} {\hat{S}}_{base}^{′} ( l + j ) {S}_{0 s b 1}^{′} ( j ) , l = 0 , … , {Δ}_{ma x 1} .$$

If Rₘₐₓ₁ is positive, the lag δ₁ corresponding to the lag with the maximum correlation Rₘₐₓ₁ is written to the SWBL1 bitstream and sent to the dequantizer. The reconstructed vector to be filled into the first zero sub-band in the dequantizer portion 111 (FIG. 1) is then computed using the following relation:

Ŝ′_{0sb1}(j)=φ₁*Ŝ′_{base}(δ₁+j), j=0, . . . , M−1,

where φ₁ is a limiting factor preventing energy increase in the first zero sub-band that is computed using the following relation:

$${ϕ}_{1} = min \{ 1 , 1 / \sqrt{{{\sum }_{j = 0}}^{M - 1} {\hat{S}}_{ base}^{′} ( {δ}_{1} + j )} \}$$

If Rₘₐₓ₁ is negative, a value of 2^{R}^{₁}−1 is written to the SWBL1 bitstream and indicates that the described technique is not supposed in this zero sub-band. In this case the filling of such zero sub-band is done using the SWBL0 output coefficients.

Similarly, if N_{base}*M>Δₘₐₓ₂+M, the detection flag f_{zd}=0 and there are at least R₂ AVQ unused bits in layer SWBL2, the maximum correlation Rₘₐₓ₂ between the base spectrum Ŝ′_{base}(k) and the vector S′_{0sb2}(j) are searched using the following relations:

$${R}_{m ax 2} = {max}_{l} {\sum }_{j = 0}^{M - 1} {\hat{S}}_{base}^{′} ( l + j ) {S}_{0 s b 2}^{′} ( j ) , 1 = 0 , … , {Δ}_{ma x 2} .$$

When δ₁ cannot be written into the SWBL1 bitstream, the vector S′_{0sb2}(j) is replaced by the vector S′_{0sb1}(j) in the previous equation. This ensures the encoding of the most important zero sub-band coefficients. If Rₘₐₓ₂ is positive, lag δ₂ corresponding to the lag with the maximum correlation Rₘₐₓ₂ is written to the SWBL2 bitstream and sent to the dequantizer. The reconstructed vector to be filled into this (first or second) zero sub-band in the dequantizer portion 111 (FIG. 1) is obtained as

Ŝ′_{0sb2}(j)=φ₂*Ŝ′_{base}(δ₂+j), j=0, . . . , M−1,

where φ₂ is a limiting factor that corresponds to this zero sub-band and is computed in the same manner as φ₁.

If Rₘₐₓ₂ is negative, a value of 2^{R}^{₂}−1 is written to the SWBL2 bitstream and indicates that the described procedure is not supposed in this zero sub-band. In this case the filling of such zero sub-band is done using the SWBL0 output coefficients.

Vectors Ŝ′_{0sb1}(j) and Ŝ′_{0sb2}(j) are used to fill zero sub-bands in the spectrum Ŝ′(k) (in operation 907 and in the dequantizer portion 111 (FIG. 1)). In coding mode≠1, they form the optimized spectrum Ŝ″(k) (see FIG. 9A). Backward ordering unit 956 (FIG. 9B) is then used to order back the sub-bands of the spectrum Ŝ″(k) (operation 906 of FIG. 9A) to the initial ordering to form the spectrum Ŝₙₒᵣₘ(k). The final operation for obtaining the reconstructed spectrum Ŝ(k) is performed by the per sub-band denormalizer 955 (FIG. 9B) and consists of denormalizing per sub-band the spectrum Ŝₙₒᵣₘ(k) (operation 905 of FIG. 9A which is the inverse of operation 901). Note that if there is more than two zero sub-bands, or there is not enough AVQ unused bits to encode lags δ₁ and δ₂, the zero sub-bands are replaced by the SWBL0 output coefficients to form the full coded SHB spectrum. It should be kept in mind that operation is performed in the dequantizer portion 111 (FIG. 1) as a response to the decoded supplemental information and operations 907 and 906 are performed in any case (supplemental information is available or not).

### Notes:

In the G.722/G.711.1 SWB extension framework the value of R₁ is set to 4 and the value of R₂ is set to 4 as well. This means that the minimum length of the base vector Ŝ′_{base}(k) must be greater than 2^{R}^{₁}−2+M=22, i.e. the base vector must be formed from 3 non-zero AVQ coded sub-bands.
The above procedure can be even used for filling the third zero sub-band if the number of AVQ unused bits is high (theoretically it could affect some 5% frames at maximum). However, this feature is not implemented in the SWB extension framework.

The value of Δₘₐₓ₁ and Δₘₐₓ₂ can be made adaptive (with changes from frame to frame and from layer to layer) according to the number of AVQ unused bits and length of the base vector Ŝ′_{base}(k).

It is possible to place at the beginning of the base vector Ŝ′_{base}(k) the sub-bands neighbouring to the zero sub-band.

FIGS. 10A-10E are schematic diagrams representing an example of the proposed technique in the G.722/G.711.1 SWB extension framework (N=8, M=8) for coding mode≠1. More specifically, FIG. 10A represents the spectrum before the AVQ coding, FIG. 10B represents the AVQ locally decoded spectrum, FIG. 10C is the base vector to be used in the maximum correlation search, FIG. 10D represents the maximum correlation search, and FIG. 10E is the reconstructed (optimized) spectrum.

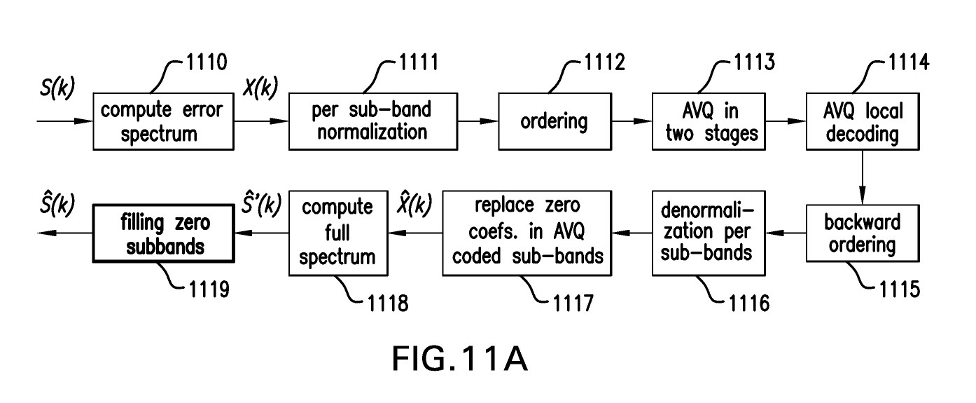

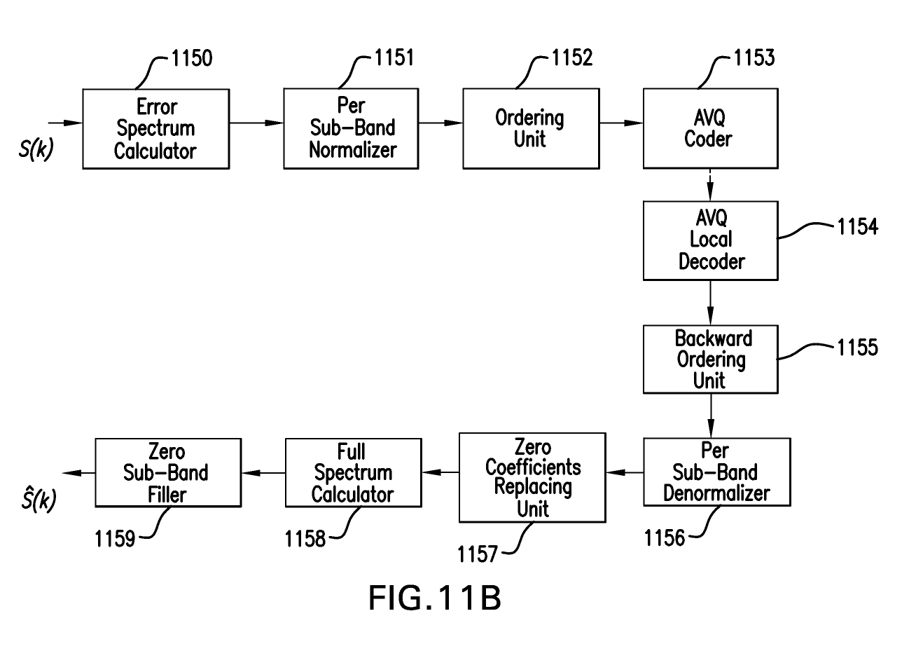

The quantizing method and quantizer as described above are slightly different for coding mode 1. The corresponding coding of the SHB spectrum in this case is illustrated in FIGS. 11A and 11B. The finding of the best vector to be filled into the zero sub-bands comprises the following steps:

Referring to FIGS. 11A and 11B, an error spectrum calculator 1150 (FIG. 11B) processes the spectrum S(k) to compute an error SHB spectrum X(k) (operation 1110 of FIG. 11A). The SHB spectrum X(k) is computed as a non-negative difference between the absolute original spectrum and the spectral envelope multiplied by 0.5. A per sub-band normalizer 1151 per-band normalizes in operation 1111 the spectrum X(k) (see Section 2.1). An ordering unit 1152 then orders the sub-bands of the per-band normalized spectrum in operation 1112 (see Section 2.1). The per sub-band normalized and ordered spectrum is then supplied to an AVQ coder 1153 and, therefore, is subjected to AVQ in two stages (operation 1113; see Section 2.2). The resulting spectrum is subsequently submitted to AVQ local decoding (operation 1114) in an AVQ decoder 1154. The quantized spectrum from operation 1114 is then subjected to backward ordering (operation 1115 which is the inverse of operation 1112) in backward ordering unit 1155 and to per sub-band denormalization (operation 1116 which is the inverse of operation 1111) in per sub-band denormalizer 1156. The zero coefficients in the AVQ coded sub-bands are then replaced in a replacing unit 1157 by the spectral envelope with the signs of the spectral coefficients corresponding to the signs of the SWBL0 output spectral coefficients to yield quantized error spectrum \hat{X}(k) (operation 1117). The full quantized spectrum is computed in calculator 1158 from error spectrum \hat{X}(k) by adding the spectral envelope multiplied by 0.5 to the absolute error spectrum for all non-zero AVQ coefficients to obtain a full quantized spectrum Ŝ′(k) (operation 1118). Finally, the zero sub-bands are filled to yield quantized spectrum Ŝ(k) (operation 1119). It should be kept in mind that operations 1114-1119 are performed in the dequantizer portion 111 (FIG. 1) as well in response to the decoded supplemental information.

The base vector is obtained by normalizing per sub-band the appropriate sub-bands from decoded normalized SHB spectrum Ŝ′(k). At the dequantizer side, the spectral coefficients originally coded by the AVQ have right signs (same as in the quantizer) while the other spectral coefficients (replaced by a spectral envelope with the signs of the spectral coefficients corresponding to the signs of the SWBL0 output spectral coefficients) have signs often different from those at the quantizer (this is due to the lack of such information at the dequantizer).

The M-dimensional vectors S′_{0sb1}(j) and S′_{0sb2}(j) are obtained by normalizing per sub-band the coefficients of the spectrum S(k) in the first two zero sub-bands. Note that the ordering of sub-bands can be omitted here.

Lags δ₁ and δ₂ that correspond to maximum correlation between the base vector and the vectors S′_{0sb1}(k) and S′_{0sb2}(k), respectively, are found. The same procedure as shown in FIG. 10 can be used.

The vectors Ŝ′_{0sb1}(j) and Ŝ′_{0sb2}(j) to fill the zero sub-bands (operation 1119) are reconstructed from the denormalized per sub-band base vector, i.e.

Ŝ′_{0sb1}(j)=φ₁*\hat{f}ₑₙᵥ(i₁)*Ŝ′_{base}(δ₁+j)

Ŝ′_{0sb2}(j)=φ₂*\hat{f}ₑₙᵥ(i₂)*Ŝ′_{base}(δ₂+j),

where j=0, . . . , M−1, and i₁ and i₂ corresponds to the first and second zero sub-bands, respectively, and φ₁ and φ₂ is the energy correction factor for zero sub-band i₁ and i₂, respectively. Calculation of the energy correction factor φ₁ and φ₂ is described in the foregoing description.

### 2.8 Energy Fix for Coding Mode 1

Another improvement can be brought to the dequantizer where reconstruction of the MDCT spectrum is computed in non-zero sub-bands for coding mode 1. It is the coding mode where the AVQ encodes the error SHB coefficients and in which AVQ coded sub-bands further replace the zero coefficients by the spectral envelope.

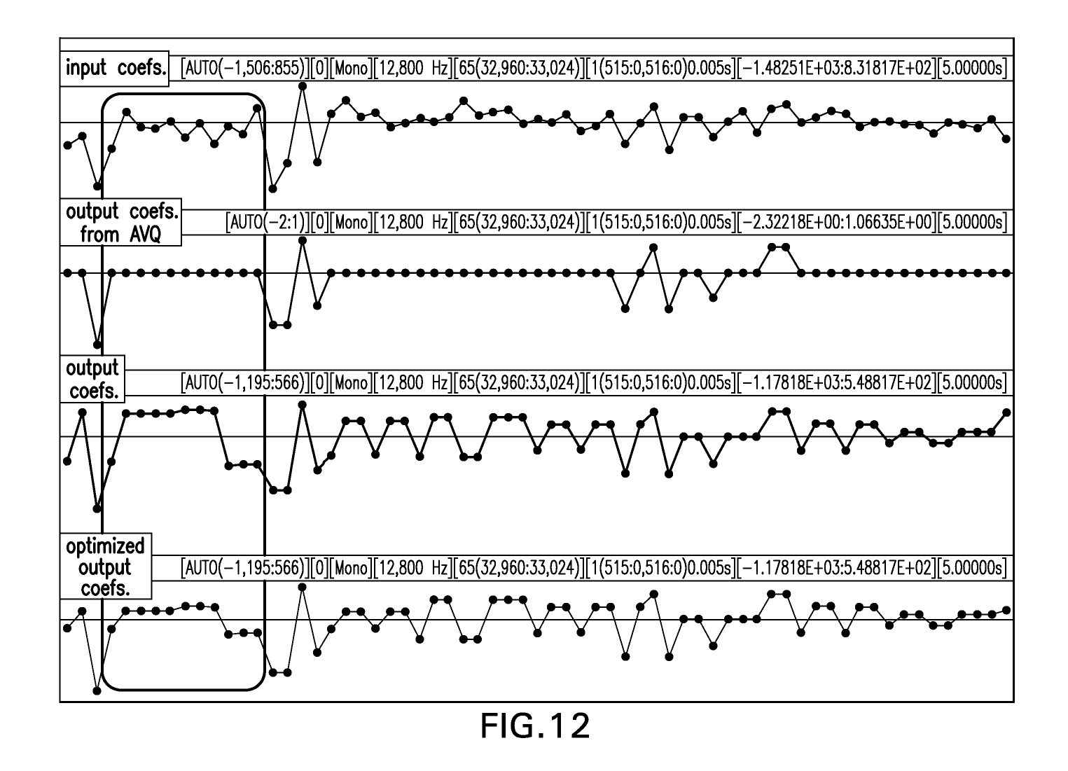

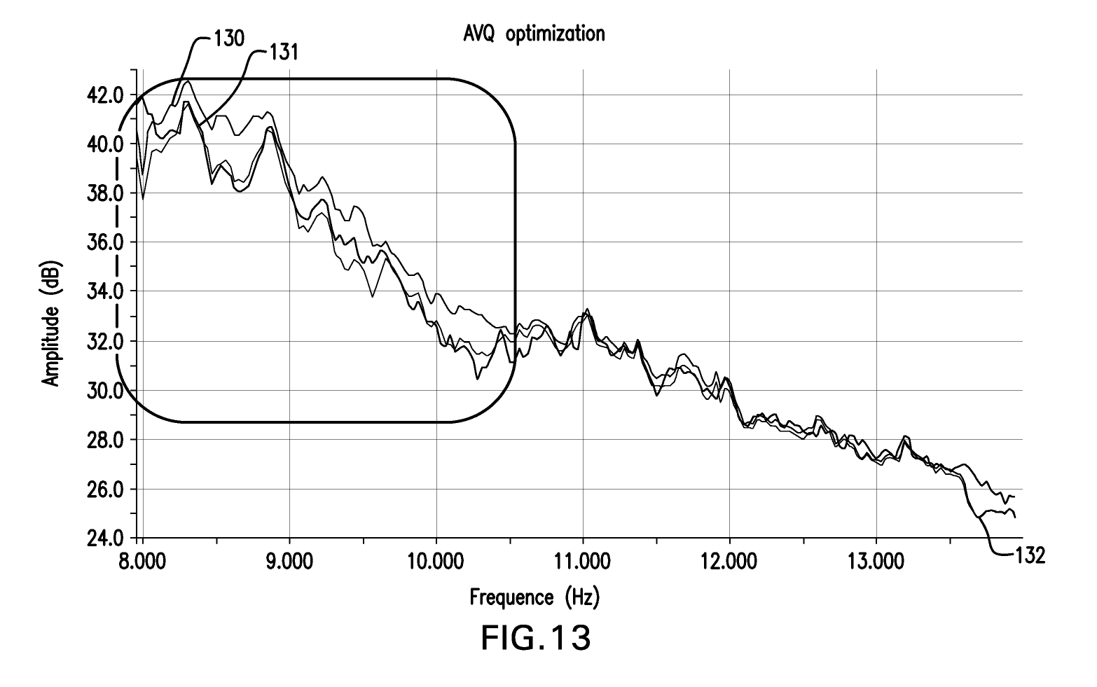

Without the proposed modification, the reconstructed spectrum is of a higher energy than the original (input) spectrum; in some cases that causes a problem. The optimization fixes the energy problem and performs a better control of the amplitudes of MDCT coefficients derived from the spectral envelope in AVQ coded sub-bands (see example in FIG. 12). The optimization improves the performance for both SWBL1 and SWBL2 output while the improvement is significant mainly for the SWBL2 output (see example in FIG. 13).

The optimization is based on the features of the AVQ. The AVQ coder is based on a RE₈ lattice structure defined as

RE₈=2D₈∪{2D₈+(1, . . . , 1)}.

The interpretation of the above equation is that any lattice point in the RE₈ lattice structure (i.e. 8-dimensional vector corresponding to one sub-band of the spectrum) has the sum of its (integer) components equal to a multiple of 4. The energy of the spectral coefficients that remain zero after the AVQ quantization can be derived from this summation feature.

If, for example, four spectral coefficients in the sub-band with length of M=8 are coded by the AVQ, the energy of the four remaining spectral coefficients do not exceed half of the energy of the spectral envelope. The knowledge of the number of spectral coefficients coded by the AVQ in a particular sub-band (cnt) as well as the amplitude of a spectral coefficient with a minimum energy (Eₘᵢₙ) in a particular non-zero sub-band i, i=0, . . . , N−1, is used. Thus the following logic is used in every non-zero sub-band:

if((f′ₑₙᵥ(i)>0.125*Eₘᵢₙ) AND (cnt=1)) f′ₑₙᵥ(i)=0.125*Eₘᵢₙ

else if((f′ₑₙᵥ(i)>0.25*Eₘᵢₙ) AND (cnt=2)) f′ₑₙᵥ(i)=0.25*Eₘᵢₙ

else if((f′ₑₙᵥ(i)>0.5*Eₘᵢₙ) AND (cnt=4)) f′ₑₙᵥ(i)=0.5*Eₘᵢₙ

where f′ₑₙᵥ(i) is the modified spectral envelope in sub-band i. The modified spectral envelope value is used for replacing the zero coefficients in the current non-zero sub-band.

### 2.9 Bit Allocation Tables in G.722/G.711.1 SWB Extension Framework

The optimizations in SHB in G.722/G.711.1 SWB extension framework have an impact on bit allocation tables used in layers SWBL1 and SWBL2. In each layer, several scenarios can occur depending on the number of AVQ unused bits. Table Ia and Table Ib, and Table II describe an example of bit allocations in layer SWBL1, and SWBL2, respectively. Note that the column “other bits” relates to AVQ unused bits reduced by bits used for encoding flag f_{zd}/f_{prob} and maximum correlation lag δ₁.

TABLE Ia
SWBL1 bit allocation table in coding mode ≠ 1.

| | gain | mode | | flag | lag | other | total |
|---|---|---|---|---|---|---|---|
| scenario # | adjustment | selection | AVQ | f_{zd} | δ₁ | bits | bits |
| scenario 1 | 3 | 1 | 36 | N/A | N/A | 0 | 40 |
| scenario 2 | 3 | 1 | 35 | 1 | N/A | 0 | 40 |
| scenario 3 | 3 | 1 | 32-34 | 1 | N/A | 1-3 | 40 |
| scenario 4 | 3 | 1 | 31 | 1 | 4 | 0 | 40 |
| scenario 5 | 3 | 1 | <31 | 1 | 4 | >0 | 40 |

TABLE Ib
SWBL1 bit allocation table in coding mode = 1.

| | gain | mode | | flag | lag | other | total |
|---|---|---|---|---|---|---|---|
| scenario # | adjustment | selection | AVQ | f_{prob} | δ₁ | bits | bits |
| scenario 1 | 3 | 1 | 36 | N/A | N/A | 0 | 40 |
| scenario 2 | 3 | 1 | 35 | 1 | N/A | 0 | 40 |
| scenario 3 | 3 | 1 | 34 | 2 | N/A | 0 | 40 |
| scenario 4 | 3 | 1 | 32-33 | 2 | N/A | 1-2 | 40 |
| scenario 5 | 3 | 1 | 31 | 1 | 4 | 0 | 40 |
| scenario 6 | 3 | 1 | 30 | 2 | 4 | 0 | 40 |
| scenario 7 | 3 | 1 | <30 | 2 | 4 | >0 | 40 |

TABLE II
SWBL2 bit allocation table for all coding modes.

| | | lag | other | total |
|---|---|---|---|---|
| scenario # | AVQ | δ₂ | bits | bits |
| scenario 1 | 40 | N/A | 0 | 40 |
| scenario 2 | 37-39 | N/A | 1-3 | 40 |
| scenario 3 | 36 | 4 | 0 | 40 |
| scenario 5 | <36 | 4 | >0 | 40 |

### 2.10 Results

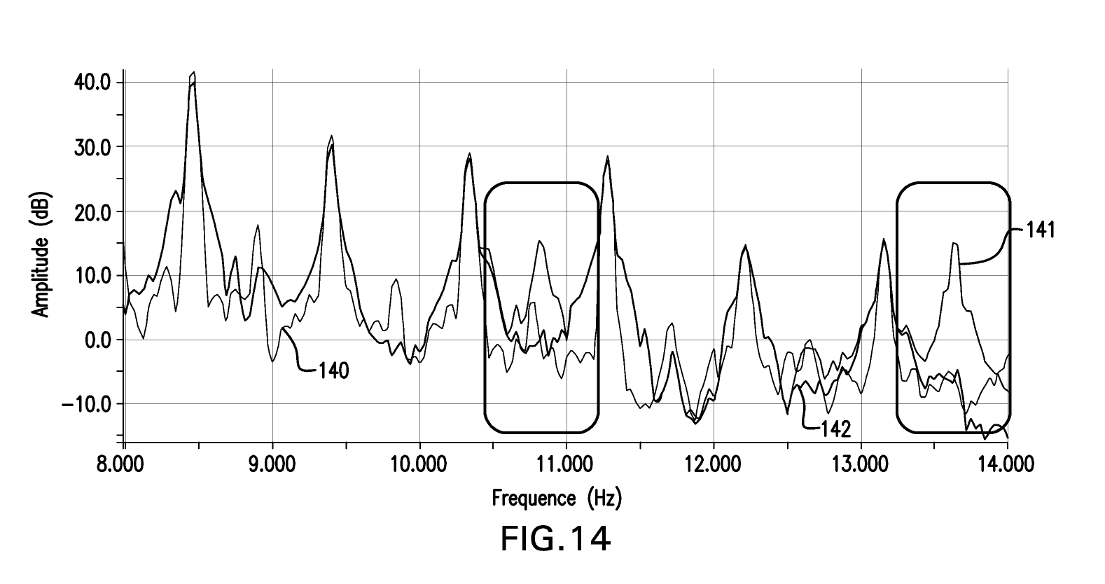

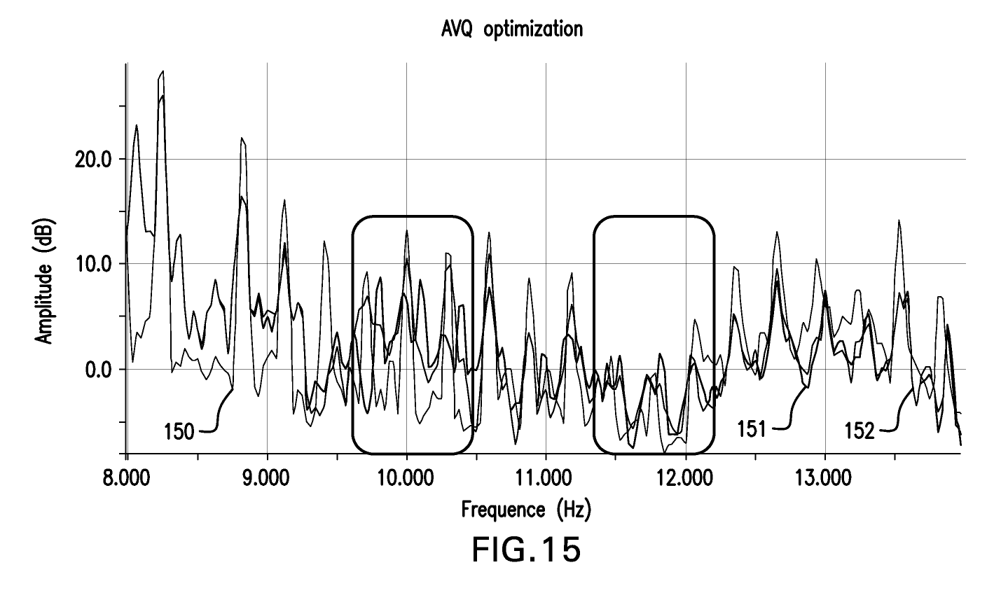

The optimizations in SHB result in increased performance of the G.722/G.711.1 SWB extension framework. This is demonstrated by the objective measure results summarized in Table III for optimizations from sections 2.5, 2.6 and 2.7. A 3-minute database of speech, mixed content and several genres of music was used for the evaluation. Further two examples show the impact of the optimization in the spectrum (FIG. 14 that illustrates the improvement achieved thanks to the detection of problematic zero sub-bands and FIG. 15 that illustrates the improvement achieved thanks to the better correlation match between the original and the reconstructed zero sub-band spectrum. The reference version refers to the version when AVQ unused bits are not employed, the optimized version references the version when AVQ unused bits are employed to optimize the performance.

TABLE III
Comparison of segmental SNR in dB for reference
and optimized version of the codec.

| configuration | SWBL1 received | SWBL2 received |
|---|---|---|
| reference, G.722 core | 1.01 | 2.97 |
| optimized, G.722 core | 1.01 | 3.52 |
| reference, G.711.1 core A-law | 1.00 | 2.96 |
| optimized, G.711.1 core A-law | 1.00 | 3.52 |

Note that the optimization does not change the output when only SWBL1 is decoded.

FIG. 14 is a graph showing an example of improvement in SHB spectrum for the SWB codec with the G.722 core at 96 kbit/s achieved thanks to the detection of problematic zero sub-bands, where curve 140 corresponds to the input spectrum, curve 141 corresponds to the output spectrum, and curve 142 corresponds to the optimized output spectrum.

FIG. 15 is a graph illustrating an example of improvement in SHB spectrum for the SWB codec with the G.722 core at 96 kbit/s achieved thanks to the better correlation match between the original and the reconstructed spectrum, wherein curve 150 corresponds to the input spectrum, curve 151 corresponds to the output spectrum, and curve 152 corresponds to the optimized output spectrum.

### 3 Optimizations in HB for the G.711.1 Core Codec

### 3.1 Current Status

The G.711.1 core codec has a bandwidth limited to 7 kHz with some attenuation around 7.0 kHz. The SWB enhancement layers then starts at 8.0 kHz to be common with the G.722 core codec. Therefore the HB spectrum enhancement is focused on improving a spectral gap mainly between 7.0-8.0 kHz. In practice, two relevant sub-bands, each of 8 coefficients, corresponding to spectrum of 6.4-8.0 kHz are coded in an enhancement layer G711 EL0. Actually, it is an error spectrum between the input signal spectrum and the G.711.1 locally decoded spectrum that is processed in this enhancement layer. The presented technique is further related only to layer G711EL0 with a bit-budget of 19 bits.

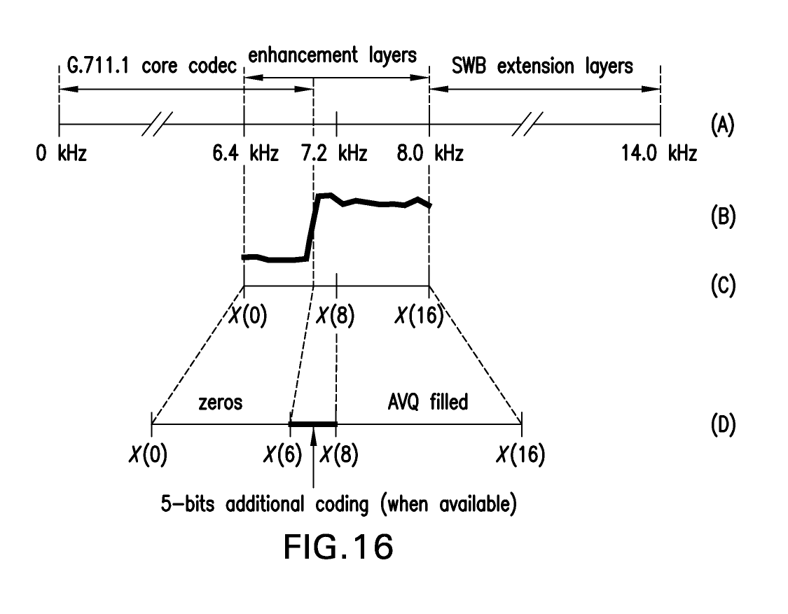

Layer G711EL0 is based on the AVQ and encodes the 6.4-8.0 kHz normalized error spectrum X(k), k=0, . . . , 2*M−1, in two sub-bands (FIG. 16C). it is noted that the normalized error spectrum X(k) discussed in this section is related to the HB and is different from the SHB error spectrum discussed in section 2.7. Giving the available bit budget in layer G711EL0 and features of the AVQ, maximally one of these two sub-bands is AVQ encoded in the given frame. This is usually the second one corresponding to the 7.2-8.0 kHz sub-band due to the higher energy of its spectral coefficients. When this second sub-band is systematically chosen and encoded for many consecutive frames, the problem appears for two middle coefficients X(6) and X(7) corresponding to the 7.0-7.2 kHz spectrum: the spectrum is missing, or significantly suppressed here. It is because the average energy of coefficients X(6) and X(7) is about the same as the average energy of coefficients X(8), . . . , X(15) and about 4 times higher than the average energy of coefficients X(0), . . . , X(5) (FIG. 16B).

FIG. 16A-16D illustrates encoding in layer G711EL0. The most part of the HB spectrum of FIG. 16A is encoded by the G.711.1 core codec. The part of the spectrum to be enhanced in layer SWBL0 is shown in FIG. 16C where FIG. 16B shows an average energy per spectral coefficient of the error spectrum. Further FIG. 16D represents an example of reconstructed spectrum when AVQ encodes the second sub-band and there are 4 AVQ unused bits.

### 3.2 Optimization in Layer G711EL0

In layer G711EL0, three bits are used to encode the global gain and 16 bits to quantize the spectrum using AVQ. The global gain is computed as

$$g = \sqrt{\frac{1}{2 * M} {\sum }_{k = 0}^{2 * M - 1} {[ X ( k ) ]}^{2}} ,$$

where X(k) are error spectral coefficients in MDCT domain and M is a number of coefficients in one sub-band, M=8 in the G.711.1 SWB framework. The HB gain is then normalized (divided) by the quantized energy corresponding to the absolute frequency envelope of the first sub-band in the SHB part of the spectrum (i.e. spectrum corresponding to 8.0-8.8 kHz), (ĝ_{glob}*\hat{f}ₑₙᵥ(0)), that is known from layer SWBL0. The normalized HB gain is quantized by means of three bits with steps logarithmically distributed in the range [0.01; 0.8]. Using this “embedded” quantization of the gain two bits can be saved when comparing to the non-embedded quantizer without a loss of accuracy.

Further, thanks to the new bitstream packing, the AVQ coding actually consumes 15 bits instead of 16 with the same coverage of the AVQ coders. This leads to the 1 remaining bit.

One of the following three scenarios can happen (Qₙ_{ᵢ} represents the AVQ sub-quantizer with a codebook number nᵢ):

1) One sub-band is coded by Q₀ and the other by Q₂, then there are 15−1−2*5=4 AVQ unused bits (15 is the bit-budget, 1 bit to encode Q₀ and nᵢ*5 bits to code Qₙ_{ᵢ}, nᵢ>0). An optimization is used in this case: a further encoding of two other spectral (MDCT) coefficients is employed using 4 AVQ unused bits and one remaining bit (described later). This happens in about 64% of frames.

2) One sub-band is coded by Q₀ and the other by Q₃, then there are 15−1−(3*5−1)=0 AVQ unused bits and no optimization is used. The remaining bit is used for encoding the tilt of 2 other spectral (MDCT) coefficients (described later). This happens in about 27% of frames.

3) One sub-band is coded by Q₀ and the other by Q₀ as well, then there are 15−1−1=13 AVQ unused bits and this quantization indicates that there is no (or a very low) spectrum to quantize. The optimization is used here, but cannot result in a significant improvement. This happens in about 9% of frames.

In practice, one of two techniques (tilt encoding, or VQ coding of two spectral coefficients) may be selected based on the number of unused bits after the AVQ coding. In other words, if ‘supplemental information’ is missing, implying that there is no available bits, tilt encoding is applied. Otherwise available bits are used to encode the two spectral coefficients.

Once the AVQ coding of one of two sub-bands is completed, further the two most important MDCT coefficients from the other sub-band are coded. One of the following two situations can happen:

A) When there is no AVQ unused bit (scenario 2) and the second sub-band is coded by the AVQ, the one remaining bit is used to encode the flag f_{HB} that represents the relative absolute amplitude of spectral coefficients X(6) and X(7) with respect to spectral coefficient \hat{X}(8) as follows: if |X(6)|>|X(7)|, then the flag f_{HB}=1, otherwise f_{HB}=0. Finally the quantized two MDCT coefficients are reconstructed in the dequantizer portion 111 (FIG. 1) as

$$\hat{X} ( 6 ) = \{ \begin{matrix}{β}_{1} * \hat{X} ( 8 ) , for {f}_{HB} = 1 \\ {β}_{2} * \hat{X} ( 8 ) , for {f}_{HB} = 0\end{matrix} \\ and \\ \hat{X} ( 7 ) = \{ \begin{matrix}{β}_{2} * \hat{X} ( 8 ) , for {f}_{HB } = 1 \\ {β}_{1} * \hat{X} ( 8 ) , for {f}_{HB} = 0\end{matrix}$$

where \hat{X}(8) is the AVQ encoded MDCT coefficient X(8) and β₁ and β₂ are two damping factors. In the G.722/G.711.1 SWB extension framework they are set as β₁=0.45 and β₂=0.35.

B) When there are 4 AVQ unused bits (scenarios 1), they are used together with the one remaining bit to code two additional MDCT coefficients. These two MDCT coefficients are coefficients X(6) and X(7) in case that AVQ codes the second sub-band (it is in about 90% of all frames), or coefficients X(8) and X(9) in case that AVQ codes the first sub-band. The available bit-budget of 5 bits (the four AVQ unused bits and one remaining bit in the G711EL0 bitstream) is used to encode signs of these two coefficients (2×1 bit) and vector-quantize the absolute amplitudes of these two coefficients (3 bits). A simple two dimensional vector quantizer can be trained for this purpose.

Scenario 3 employs 5 bits in the same way as scenario 1. In this case, 9 bits remain unused.

The bit allocation table for these three scenarios 1, 2 and 3 in layer G711EL0 is illustrated in Table IV.

TABLE IV
G711EL0 bit allocation table.

| | | | Signs + | | | |
|---|---|---|---|---|---|---|
| | | | absolute | | | |
| | HB | | amplitudes of | | | |
| | residual | AVQ | two MDCT | flag | Unused | Total |
| Scenario # | noise gain | indices | coefficients | f_{HB} | bits | bits |
| Scenario 1 | 3 | 11 | 2 + 3 | N/A | 0 | 19 |
| Scenario 2 | 3 | 15 | N/A | 1 | 0 | 19 |
| Scenario 3 | 3 | 2 | 2 + 3 | N/A | 9 | 19 |

3.3 Results

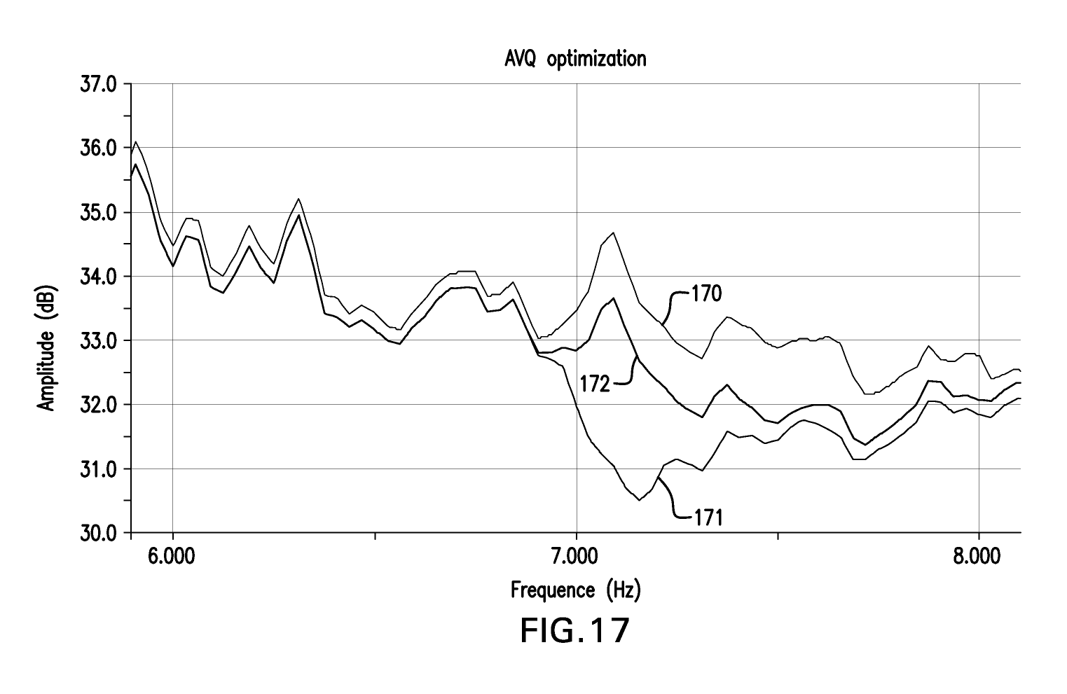

When employing the AVQ unused bits using the optimization technique from Section 3.2, improvement is obtained with respect to the reference version where the AVQ unused bits were not employed. A segmental SNR comparison measured in MDCT domain for HB (4.0-8.0 kHz) spectrum for the SWB codec with the G.711.1 core, A-law, is shown in Table V. A 3-minute database of speech, mixed content and several genres of music was used. Also an example of spectrum comparison is shown in FIG. 17. It can be noted that the optimization technique encodes two additional coefficients in certain frames only.

TABLE V
Comparison of segmental SNR in dB for reference
and optimized version of the codec.

| | core layer | G711EL0 | G711EL1 |
|---|---|---|---|
| configuration | received | received | received |
| reference, G.711.1 core A-law | 8.53 | 9.80 | 12.34 |
| optimized, G.711.1 core A-law | 8.53 | 10.87 | 13.19 |

The foregoing disclosure relates to non-restrictive, illustrative embodiments, and these embodiments can be modified at will, within the scope of the appended claims.

What is claimed is:

1. A multi-rate algebraic vector quantizer for coding spectral coefficients of a plurality of frequency sub-bands, comprising:
a quantizer portion supplied with the spectral coefficients of the sub-bands, the quantizer portion having a plurality of codebooks each including a plurality of vectors, and first coders of quantizer parameters identifying the codebooks and vectors used for coding the spectral coefficients of the sub-bands; and
a second coder of supplemental information usable to improve, at a dequantizer, decoded spectral coefficients of the sub-bands.

2. A multi-rate algebraic vector quantizer for coding spectral coefficients of a plurality of frequency sub-bands, comprising:
a quantizer portion supplied with the spectral coefficients of the sub-bands, the quantizer portion having a plurality of codebooks each including a plurality of vectors, and first coders of quantizer parameters identifying the codebooks and vectors used for coding the spectral coefficients of the sub-bands; and
a second coder of supplemental information usable to improve, at a dequantizer, decoded spectral coefficients of the sub-bands;
wherein the second coder uses bits unused for quantization.

3. A multi-rate algebraic vector quantizer for coding spectral coefficients of a plurality of frequency sub-bands, comprising:
a quantizer portion supplied with the spectral coefficients of the sub-bands, the quantizer portion having a plurality of codebooks each including a plurality of vectors, and first coders of quantizer parameters identifying the codebooks and vectors used for coding the spectral coefficients of the sub-bands; and
a second coder of supplemental information usable to improve, at a dequantizer, decoded spectral coefficients of the sub-bands;
wherein the sub-bands comprises zero sub-bands and the supplemental information is structured to improve the zero sub-bands.

4. A multi-rate algebraic vector quantizer for coding spectral coefficients of a plurality of frequency sub-bands, comprising:
a quantizer portion supplied with the spectral coefficients of the sub-bands, the quantizer portion having a plurality of codebooks each including a plurality of vectors, and first coders of quantizer parameters identifying the codebooks and vectors used for coding the spectral coefficients of the sub-bands;
a second coder of supplemental information usable to improve, at a dequantizer, decoded spectral coefficients of the sub-bands; and
a classifier of sub-bands to detect zero sub-bands of the plurality of sub-bands whose reconstruction is anticipated to be inaccurate, wherein the classifier produces a detection flag transmitted to the dequantizer as supplemental information.

5. A multi-rate algebraic vector quantizer as defined in claim 4, wherein the classifier calculates a detection counter indicative of a zero sub-band whose reconstruction is anticipated to be inaccurate, and wherein the classifier produces the detection flag in response to the detection counter.

6. A multi-rate algebraic vector quantizer for coding spectral coefficients of a plurality of frequency sub-bands, comprising:
a quantizer portion supplied with the spectral coefficients of the sub-bands, the quantizer portion having a plurality of codebooks each including a plurality of vectors, and first coders of quantizer parameters identifying the codebooks and vectors used for coding the spectral coefficients of the sub-bands; and
a second coder of supplemental information usable to improve, at a dequantizer, decoded spectral coefficients of the sub-bands;
wherein the quantizer portion comprises a searcher of a maximum correlation lag corresponding to a maximum correlation between an original spectrum in a zero sub-band and a base spectrum, the lag being sent to the dequantizer as supplemental information.

7. A multi-rate algebraic vector quantizer as defined in claim 6, wherein the original spectrum is a per sub-band normalized and a sub-band ordered spectrum.

8. The multi-rate algebraic vector quantizer as defined in claim 6, wherein the base spectrum is extracted from a decoded spectrum.

9. A multi-rate algebraic vector quantizer as defined in claim 6, wherein the quantizer portion comprises a filler of the zero sub-bands with vectors calculated from the base spectrum using the maximum correlation lag.

10. A multi-rate algebraic vector quantizer for coding spectral coefficients of a plurality of frequency sub-bands, comprising:
a quantizer portion supplied with the spectral coefficients of the sub-bands, the quantizer portion having a plurality of codebooks each including a plurality of vectors, and first coders of quantizer parameters identifying the codebooks and vectors used for coding the spectral coefficients of the sub-bands; and
a second coder of supplemental information usable to improve, at a dequantizer, decoded spectral coefficients of the sub-bands;
wherein the sub-bands comprises zero sub-bands, and wherein the quantizer portion fills the zero sub-bands with spectral coefficients derived from sub-bands coded by the quantizer portion.

11. A multi-rate algebraic vector quantizer as defined in claim 1, wherein the quantizer portion fills a spectral gap in an embedded coding scheme.

12. A multi-rate algebraic vector quantizer for coding spectral coefficients of a plurality of frequency sub-bands, comprising:
a quantizer portion supplied with the spectral coefficients of the sub-bands, the quantizer portion having a plurality of codebooks each including a plurality of vectors, and first coders of quantizer parameters identifying the codebooks and vectors used for coding the spectral coefficients of the sub-bands; and
a second coder of supplemental information usable to improve, at a dequantizer, decoded spectral coefficients of the sub-bands;
wherein the quantizer portion fills a spectral gap in an embedded coding scheme through an adaptive selection of a technique for coding additional spectral coefficients sent to the dequantizer as supplemental information.

13. A multi-rate algebraic vector quantizing method for coding spectral coefficients of a plurality of frequency sub-bands, comprising:
quantizing the spectral coefficients of the sub-bands, quantizing the spectral coefficients comprising using a plurality of codebooks each including a plurality of vectors and coding quantizer parameters identifying the codebooks and vectors used for coding the spectral coefficients of the sub-bands; and
coding supplemental information usable to improve, at a dequantizer, decoded spectral coefficients of the sub-bands.

14. A multi-rate algebraic vector quantizing method as defined in claim 13, wherein coding supplemental information comprises using bits unused for quantization.

15. A multi-rate algebraic vector quantizing method as defined in claim 13, wherein the sub-bands comprises zero sub-bands and the supplemental information is structured to improve the zero sub-bands.

16. A multi-rate algebraic vector quantizing method as defined in claim 13, comprising classifying the sub-bands to detect zero sub-bands of the plurality of sub-bands whose reconstruction is anticipated to be inaccurate, wherein classifying the sub-bands comprises producing a detection flag transmitted to the dequantizer as supplemental information.

17. A multi-rate algebraic vector quantizing method as defined in claim 16, wherein classifying the sub-bands comprises calculating a detection counter indicative of a zero sub-band whose reconstruction is anticipated to be inaccurate, and producing the detection flag in response to the detection counter.

18. A multi-rate algebraic vector quantizing method as defined in claim 13, wherein quantizing the spectral coefficients comprises searching a maximum correlation lag corresponding to a maximum correlation between an original spectrum in a zero sub-band and a base spectrum, the lag being sent to the dequantizer as supplemental information.

19. A multi-rate algebraic vector quantizing method as defined in claim 18, wherein the original spectrum is a per sub-band normalized and a sub-band ordered spectrum.

20. A multi-rate algebraic vector quantizing method as defined in claim 18, wherein the base spectrum is extracted from a decoded spectrum.

21. A multi-rate algebraic vector quantizing method as defined in claim 18, wherein quantizing the spectral coefficients comprises filling the zero sub-bands with vectors calculated from the base spectrum using the maximum correlation lag.

22. A multi-rate algebraic vector quantizing method as defined in claim 13, wherein the sub-bands comprises zero sub-bands, and wherein quantizing the spectral coefficients comprises filling the zero sub-bands with spectral coefficients derived from sub-bands coded by the quantizer portion.

23. A multi-rate algebraic vector quantizing method as defined in claim 13, wherein quantizing the spectral coefficients comprises filling a spectral gap in an embedded coding scheme.

24. A multi-rate algebraic vector quantizing method as defined in claim 23, wherein quantizing the spectral coefficients comprises filling the spectral gap through an adaptive selection of a technique for coding additional spectral coefficients sent to the dequantizer as supplemental information.

25. A multi-rate algebraic vector dequantizer for decoding spectral coefficients of a plurality of sub-bands of a spectrum, comprising:
first decoders of received, coded quantizer parameters identifying codebooks and vectors of the codebooks used for coding the spectral coefficients of the sub-bands;
a second decoder of received, coded supplemental information usable to improve the decoded spectral coefficients of the sub-bands;
a dequantizer portion supplied with the decoded quantizer parameters and the decoded supplemental information and having an output for the decoded spectral coefficients.

26. A multi-rate algebraic vector dequantizer for decoding spectral coefficients of a plurality of sub-bands of a spectrum, comprising:
first decoders of received, coded quantizer parameters identifying codebooks and vectors of the codebooks used for coding the spectral coefficients of the sub-bands;
a second decoder of received, coded supplemental information usable to improve the decoded spectral coefficients of the sub-bands;
a dequantizer portion supplied with the decoded quantizer parameters and the decoded supplemental information and having an output for the decoded spectral coefficients;
wherein the sub-bands of the spectrum comprises zero sub-bands, and wherein the supplemental information comprises a detection flag indicative of detection of zero sub-bands whose reconstruction is anticipated to be inaccurate.

27. A multi-rate algebraic vector dequantizer as defined in claim 26, wherein the dequantizer portion fills, in response to a value of the detection flag, the zero sub-bands using a restrained spectral envelope.

28. A multi-rate algebraic vector dequantizer as defined in claim 26, wherein the dequantizer portion replaces, in response to a value of the detection flag, the zero sub-bands by output spectral coefficients from one bitstream layer.

29. A multi-rate algebraic vector dequantizer as defined in claim 26, wherein the sub-bands of the spectrum also comprises non-zero sub-bands, and wherein the dequantizer portion fills, in response to a value of the detection flag, the zero sub-bands with coefficients derived from coded spectral coefficients from non-zero sub-bands.

30. A multi-rate algebraic vector dequantizer for decoding spectral coefficients of a plurality of sub-bands of a spectrum, comprising:
first decoders of received, coded quantizer parameters identifying codebooks and vectors of the codebooks used for coding the spectral coefficients of the sub-bands;
a second decoder of received, coded supplemental information usable to improve the decoded spectral coefficients of the sub-bands;
a dequantizer portion supplied with the decoded quantizer parameters and the decoded supplemental information and having an output for the decoded spectral coefficients;
wherein the supplemental information comprises a maximum correlation lag corresponding to a maximum correlation between an original spectrum in a zero sub-band and a base spectrum, and wherein the dequantizer portion fills zero sub-band with vector calculated from the base spectrum using the maximum correlation lag.

31. A multi-rate algebraic vector dequantizer for decoding spectral coefficients of a plurality of sub-bands of a spectrum, comprising:
first decoders of received, coded quantizer parameters identifying codebooks and vectors of the codebooks used for coding the spectral coefficients of the sub-bands;
a second decoder of received, coded supplemental information usable to improve the decoded spectral coefficients of the sub-bands;
a dequantizer portion supplied with the decoded quantizer parameters and the decoded supplemental information and having an output for the decoded spectral coefficients;
wherein the non-zero sub-bands comprises zero spectral coefficients, and the dequantizer portion uses a modified spectral envelope for replacing zero coefficients in a current non-zero sub-band.

32. A multi-rate algebraic vector dequantizer for decoding spectral coefficients of a plurality of sub-bands of a spectrum, comprising:
first decoders of received, coded quantizer parameters identifying codebooks and vectors of the codebooks used for coding the spectral coefficients of the sub-bands;
a second decoder of received, coded supplemental information usable to improve the decoded spectral coefficients of the sub-bands;
a dequantizer portion supplied with the decoded quantizer parameters and the decoded supplemental information and having an output for the decoded spectral coefficients;
wherein the dequantizer portion fills a spectral gap in an embedded coding scheme using additional spectral coefficients coded and received as supplemental information.

33. A multi-rate algebraic vector dequantizing method for decoding spectral coefficients of a plurality of frequency sub-bands, comprising:
decoding received, coded quantizer parameters identifying codebooks and vectors of the codebooks used for coding the spectral coefficients of the sub-bands;
decoding received, coded supplemental information usable to improve the decoded spectral coefficients of the sub-bands;
dequantizing the decoded quantizer parameters and the decoded supplemental information to produce the decoded spectral coefficients.

34. A multi-rate algebraic vector dequantizing method as defined in claim 33, wherein the sub-bands of the spectrum comprises zero sub-bands, wherein the supplemental information comprises a detection flag indicative of detection of zero sub-bands whose reconstruction is anticipated to be inaccurate.

35. A multi-rate algebraic vector dequantizing method as defined in claim 34, wherein dequantizing the decoded quantizer parameters and the decoded supplemental information comprises filling, in response to a value of the detection flag, the zero sub-bands using a restrained spectral envelope.

36. A multi-rate algebraic vector dequantizing method as defined in claim 34, wherein dequantizing the decoded quantizer parameters and the decoded supplemental information comprises replacing, in response to a value of the detection flag, the zero sub-bands by output spectral coefficients from one bitstream layer.

37. A multi-rate algebraic vector dequantizing method as defined in claim 34, wherein the sub-bands of the spectrum also comprises non-zero sub-bands, and wherein dequantizing the decoded quantizer parameters and the decoded supplemental information comprises filling, in response to a value of the detection flag, the zero sub-bands with coefficients derived from coded spectral coefficients from non-zero sub-bands.

38. A multi-rate algebraic vector dequantizing method as defined in claim 33, wherein the sub-bands comprises zero sub-bands, and wherein the supplemental information comprises a maximum correlation lag corresponding to a maximum correlation between an original spectrum in a zero sub-band and a base spectrum, and wherein dequantizing the decoded quantizer parameters and the decoded supplemental information comprises filling zero sub-bands with vectors calculated from the base spectrum using the maximum correlation lag.

39. A multi-rate algebraic vector dequantizing method as defined in claim 33, wherein the sub-bands comprises zero and non-zero sub-bands, and wherein dequantizing the decoded quantizer parameters and the decoded supplemental information comprises using a modified spectral envelope for replacing zero coefficients in a current non-zero sub-band.

40. A multi-rate algebraic vector dequantizing method as defined in claim 33, wherein dequantizing the decoded quantizer parameters and the decoded supplemental information comprises filling a spectral gap in an embedded coding scheme using additional spectral coefficients coded and received as supplemental information.
